(19) United States
(12) Patent Application Publication
(10) Pub. No.: US 2014/0184778 A1
(43) Pub. Date: Jul. 3, 2014

(54) IMAGE PROCESSING APPARATUS, CONTROL METHOD FOR THE SAME, IMAGE PROCESSING SYSTEM, AND PROGRAM

(71) Applicant: CANON KABUSHIKI KAISHA, Tokyo (JP)

(72) Inventor: Tomohiko Takayama, Tokyo (JP)

(73) Assignee: CANON KABUSHIKI KAISHA, Tokyo (JP)

(21) Appl. No.: 14/140,840

(22) Filed: Dec. 26, 2013

(30) Foreign Application Priority Data
Dec. 28, 2012 (JP) 2012-287576

(51) Int. Cl. G02B 21/36

(52) U.S. Cl. CPC G02B 21/367
USPC 348/79

(57) ABSTRACT

An image processing apparatus is configured to generate a display image used to display a captured image captured by imaging a slide on which a specimen is placed. The image processing apparatus includes an acquisition unit configured to acquire an overall image generated from the captured image for displaying the entirety of the slide and a magnified image generated from the captured image for displaying a portion of the specimen in a magnified manner and a generation unit configured to generate a display image containing the overall image and the magnified image. The magnified image is a rotated image rotated relative to the overall image on the basis of specimen information about a feature of the specimen displayed in a magnified manner.

### BACKGROUND OF THE INVENTION

1. Field of the Invention

The present invention relates to an image processing apparatus, a control method for the same, an image processing system, and a program.

2. Description of the Related Art

Virtual slide systems that capture a virtual slide image by imaging a specimen on a slide using a digital microscope and display the virtual slide image on a monitor to allow observation have been receiving attention (see Japanese Patent Application Laid-Open No. 2011-118107).

Image presentation techniques enabling efficient display of reduced or magnified images having large data sizes have been known (see Japanese Patent Application Laid-Open No. 2011-170480).

### SUMMARY OF THE INVENTION

In the virtual slide system disclosed in Japanese Patent Application Laid-Open No. 2011-118107, when there are a plurality of specimens on a slide, it is necessary to perform screening of individual specimen on a specimen-by-specimen basis with care not to overlook a specimen, making the specimen observation burdensome.

The display technique disclosed in Japanese Patent Application Laid-Open No. 2011-170480 enables a reduction of the possibility of overlook of individual specimens, but it does not reduce the burden in screening of individual specimens.

The present invention provides an image processing apparatus with which the burden in specimen observation (or screening) can be lightened in cases where there are a plurality of specimens on a slide.

According to a first aspect of the present invention, there is provided an image processing apparatus configured to generate a display image used to display on a display apparatus a captured image captured by imaging a slide on which a specimen is placed by an imaging apparatus, comprising:

an acquisition unit configured to acquire an overall image generated from the captured image for displaying the entirety of the slide and a magnified image generated from the captured image for displaying a portion of the specimen in a magnified manner; and

a generation unit configured to generate a display image containing the overall image and the magnified image,

wherein the magnified image is a rotated image rotated relative to the overall image on the basis of specimen information about a feature of the specimen displayed in the magnified manner.

According to a second aspect of the present invention, there is provided a control method for an image processing apparatus configured to generate a display image used to display on a display apparatus a captured image captured by imaging a slide on which a specimen is placed by an imaging apparatus, comprising:

an acquisition step of acquiring an overall image generated from the captured image for displaying the entirety of the slide and a magnified image generated from the captured image for displaying a portion of the specimen in a magnified manner; and

a generation step of generating a display image containing the overall image and the magnified image,

wherein the magnified image is a rotated image rotated relative to the overall image on the basis of specimen information about a feature of the specimen displayed in the magnified manner.

According to a third aspect of the present invention, there is provided a program that causes a computer to control an image processing apparatus configured to generate a display image used to display on a display apparatus a captured image captured by imaging a slide on which a specimen is placed by an imaging apparatus, the program causing the computer to execute:

an acquisition step of acquiring an overall image generated from the captured image for displaying the entirety of the slide and a magnified image generated from the captured image for displaying a portion of the specimen in a magnified manner; and

a generation step of generating a display image containing the overall image and the magnified image,

wherein the magnified image is a rotated image rotated relative to the overall image on the basis of specimen information about a feature of the specimen displayed in the magnified manner.

According to a fourth aspect of the present invention, there is provided an image processing apparatus configured to generate a display image used to display on a display apparatus a captured image captured by imaging a slide on which a plurality of specimens are placed by an imaging apparatus, comprising:

an acquisition unit configured to acquire an overall image generated from the captured image for displaying the entirety of the slide, a specimen image for displaying the entirety of a selected specimen among the plurality of specimens, and a magnified image for displaying a portion of the specimen displayed by the specimen image in a magnified manner; and

a generation unit configured to generate a display image containing the overall image, the specimen image, and the magnified image,

wherein the specimen image is an image rotated relative to the overall image on the basis of specimen information about a feature of the specimen displayed by the specimen image, and the magnified image is an image not rotated relative to the specimen image.

According to a fifth aspect of the present invention, there is provided a control method for an image processing apparatus configured to generate a display image used to display on a display apparatus a captured image captured by imaging a slide on which a plurality of specimens are placed by an imaging apparatus, comprising:

an acquisition step of acquiring an overall image generated from the captured image for displaying the entirety of the slide, a specimen image for displaying the entirety of a selected specimen among the plurality of specimens, and a magnified image for displaying a portion of the specimen displayed by the specimen image in a magnified manner; and

a generation step of generating a display image containing the overall image, the specimen image, and the magnified image,

wherein the specimen image is an image rotated relative to the overall image on the basis of specimen information about a feature of the specimen displayed by the specimen image, and the magnified image is an image not rotated relative to the specimen image.

The present invention can reduce the burden on a user in performing observation (screening) of specimens in cases where there are a plurality of specimens on a slide.

Further features of the present invention will become apparent from the following description of exemplary embodiments with reference to the attached drawings.

### BRIEF DESCRIPTION OF THE DRAWINGS

FIG. 1 is a diagram showing the configuration of apparatuses in an image processing system.

FIG. 2 is a functional block diagram of an imaging apparatus.

FIG. 3 is a diagram showing the hardware configuration of an image processing apparatus.

FIG. 4 is a block diagram of a control unit of the image processing apparatus.

FIG. 5 is a schematic diagram showing the structure of multi-layer image data.

FIG. 6 is a schematic diagram showing a slide on which a plurality of specimens are placed.

FIGS. 7A to 7C show an exemplary screen of an image presentation application.

FIGS. 8A and 8B are schematic diagrams illustrating a method of setting an image presentation mode in the image presentation application.

FIGS. 9A to 9C are schematic diagrams illustrating image rotation based on specimen information (specimen shape) and a presented image.

FIG. 10 is a flow chart of the image rotation based on the specimen information (specimen shape).

FIGS. 11A to 11C are schematic diagrams illustrating image rotation based on specimen information (specimen characteristics) and a presented image.

FIG. 12 is a flow chart of the image rotation based on the specimen information (specimen characteristics).

FIG. 13A to 13E are schematic diagrams illustrating image rotation based on the smallest circumscribed rectangle and a presented image.

FIG. 14 is a flow chart of the image rotation based on the smallest circumscribed rectangle.

FIG. 15A and 15B show an exemplary screen of the image presentation application.

FIGS. 16A and 16B are schematic diagram illustrating a process of designating an individual specimen in the third image.

FIGS. 17A to 17E are schematic diagrams illustrating shift of an observation area.

FIGS. 18A and 18B are schematic diagrams illustrating multi-layer image data additionally having a depth structure.

FIG. 19 is a schematic diagram showing a three-dimensional specimen.

FIG. 20 is a schematic diagram illustrating imaging of the three-dimensional specimen.

FIGS. 21A to 21C are schematic diagrams illustrating a main cross section of the three-dimensional specimen.

FIGS. 22A to 22C show an exemplary screen of an image presentation application.

FIG. 23 is a flow chart of a process of generating an image of the main cross section of the three-dimensional specimen.

FIGS. 24A and 24B show an exemplary screen of an image presentation application.

### DESCRIPTION OF THE EMBODIMENTS

### First Embodiment

In the following, embodiments of the present invention will be described with reference to the drawings.

### (Construction of Image Processing System)

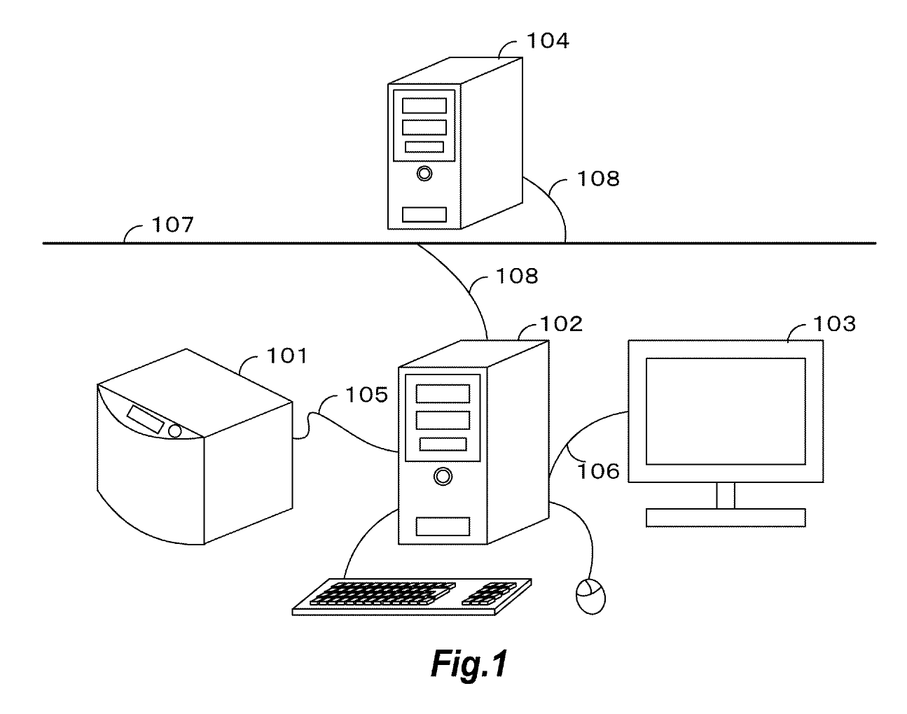

The image processing apparatus according to the present invention can be used in an image processing system including an imaging apparatus and a display apparatus. Such an image processing system will be described with reference to FIG. 1.

FIG. 1 is a diagram showing an image processing system using an image processing apparatus according to the present invention. The image processing system includes an imaging apparatus (digital microscope device or virtual slide scanner) 101, an image processing apparatus 102, a display apparatus 103, and a data server 104. This system has the functions of acquiring a two-dimensional image of a specimen as an object of imaging and displaying the two-dimensional image. The imaging apparatus 101 and the image processing apparatus 102 are interconnected by a special-purpose or general-purpose I/F cable 105. The image processing apparatus 102 and the display apparatus 103 are interconnected by a general-purpose I/F cable 106. The data server 104 and the image processing apparatus 102 are interconnected via a network 107 using a general-purpose I/F LAN cable 108.

The imaging apparatus 101 is a virtual slide scanner that performs imaging at a plurality of different positions in a two-dimensional plane to output digital image data of a plurality of two-dimensional images. The imaging apparatus 101 uses a solid-state imaging element such as a CCD (Charge Coupled Device) or a CMOS (Complementary Metal Oxide Semiconductor) to acquire two-dimensional images. The virtual slide scanner serving as the imaging apparatus 101 may be replaced by a digital microscope apparatus constituted by an ordinary optical microscope and a digital camera attached to the eyepiece of the optical microscope.

The image processing apparatus 102 is an apparatus having the function of generating, responsive to a user's request, data (display data) of an image to be displayed on the display apparatus 103 from data of a plurality of original images (captured images) acquired through the imaging apparatus 101. The image processing apparatus 102 has hardware resources such as a CPU (Central Processing Unit), a RAM (Random Access Memory), a storage device, an operation unit, and various interfaces. The image processing apparatus 102 is constituted by a general-purpose computer or workstation. The storage device is, for example, a large capacity information storage device such as a hard disk drive, in which a program(s) and data used to implement later described various processing and an operating system (OS) are stored. The above-described functions are carried out by the CPU by loading a program(s) and data as needed to the RAM from the storage device and executing the program(s). The operation unit includes a keyboard and/or mouse or the like, which is used by the user to input various commands to the image processing apparatus 102.

The display apparatus 103 is a display such as a CRT (Cathode-Ray Tube) or liquid crystal display, which is used to display images (images for observation) based on display data generated by the image processing apparatus 102.

The data server 104 is a server in which diagnosis reference information (data relevant to standard of diagnosis) that serves as a guideline for the user in diagnosing specimens is stored. The diagnosis reference information is updated whenever needed to catch up with up-to-date knowledge of pathological diagnosis. The data server 104 is configured to update the storage content in line with the updating of the diagnosis reference information.

FIG. 1 shows an exemplary system configuration constituted by four apparatuses including the imaging apparatus 101, the image processing apparatus 102, the display apparatus 103, and the data server 104. The configuration of the image processing system according to the present invention is not limited to this exemplary configuration. For example, the image processing apparatus and the display apparatus may be an integrated apparatus. The function of the image processing apparatus may be implemented in the imaging apparatus. The system may be constituted by a single apparatus having the functions of all of the imaging apparatus, the image processing apparatus, the display apparatus, and the data server. Alternatively, the functions of each apparatus, e.g. the image processing apparatus, may be implemented by separate apparatuses respectively. In other words, each apparatus, e.g. the image processing apparatus, may be constituted by a plurality of apparatuses.

### (Functional Configuration of Imaging Apparatus)

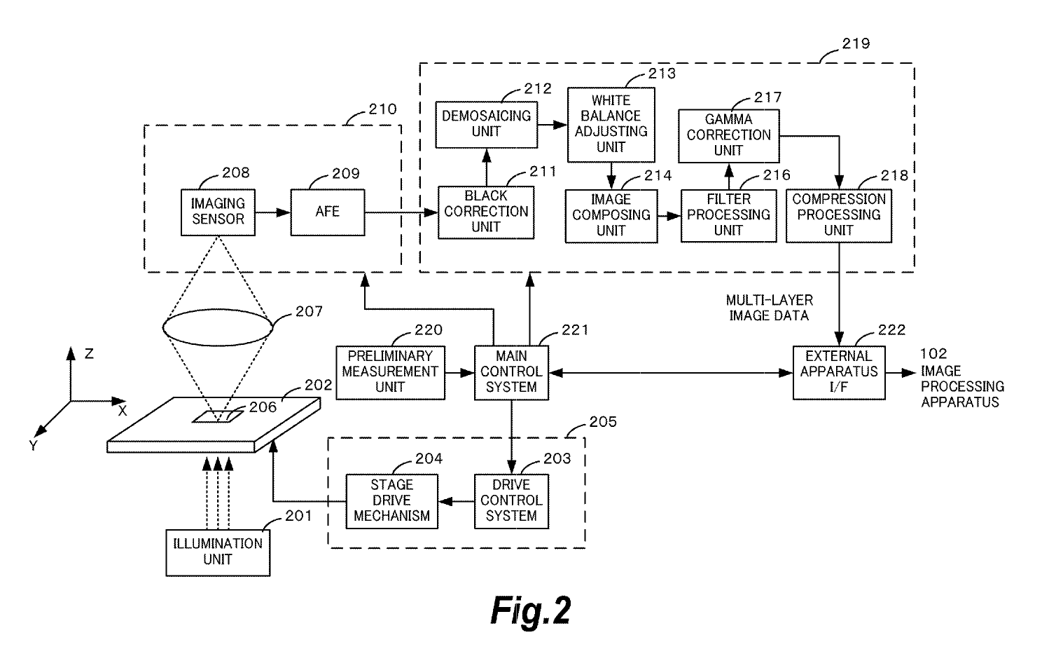

FIG. 2 is a block diagram showing the functional configuration of the imaging apparatus 101.

The imaging apparatus 101 is basically composed of an illumination unit 201, a stage 202, a stage control unit 205, an image forming optical system 207, an imaging unit 210, a developing unit 219, a preliminary measurement unit 220, a main control system 221, and an external apparatus I/F 222.

The illumination unit 201 is a unit illuminating a slide 206 placed on the stage 202 uniformly with light. The illumination unit includes a light source, an illumination optical system, and a control system for driving the light source. The stage 202 is driven under control of the stage control unit 205 so as to be capable of shifting in the three axial directions, or the X, Y, and Z directions. The slide 206 is a piece prepared by placing a slice of tissue or a smear of cells to be observed on a slide glass and fixing it under a cover glass with mounting agent.

The stage control unit 205 includes a drive control system 203 and a stage drive mechanism 204. The drive control system 203 receives commands from the main control system 221 to perform drive control for the stage 202. The direction of shift and the amount of shift of the stage 202 are determined based on position information and thickness information (or distance information) about the specimen obtained by measurement performed by the preliminary measurement unit 220 and on a command input by the user if needed. The stage drive mechanism 204 drives the stage 202 according to commands from the drive control system 203.

The image forming optical system 207 is a lens unit that forms an optical image of the specimen on the slide 206 on an imaging sensor 208.

The imaging unit 210 includes the imaging sensor 208 and an analogue front end (AFE) 209. The imaging sensor 208 is a one-dimensional or two-dimensional image sensor such as a CCD or CMOS device that converts a two-dimensional optical image into a physical or electrical quantity by photoelectric conversion. In the case where the image pickup sensor 208 is a one-dimensional sensor, a two-dimensional image is obtained by electrical scanning along a main scanning direction and moving the stage 202 along a sub-scanning direction. The imaging sensor 208 outputs an electrical signal having a voltage value correlating with the light intensity. In the case where a color image is to be captured, a single image sensor to which a color filter having a Bayer arrangement is attached may be used for example. The imaging unit 210 drives the stage 202 along the X axis direction and the Y axis direction to capture divisional images of the specimen.

The AFE 209 is a circuit that converts an analog signal output by the image pickup sensor 208 into a digital signal. The AFE 209 includes an H/V driver described later, a CDS (Correlated Double Sampling), an amplifier, an AD converter, and a timing generator. The H/V driver converts a vertical synchronizing signal and a horizontal synchronizing signal for driving the imaging sensor 208 into voltages required to drive the sensor.

The CDS is a correlated double sampling circuit for removing fixed pattern noises.

The amplifier is an analog amplifier that adjusts the gain of the analog signal from which noises have been removed by the CDS.

The AD converter converts an analog signal into a digital signal. In the case where the resolution of the data that the image pickup apparatus 101 finally outputs is 8 bits, the AD converter may convert the analog signal into digital data quantized generally in 10 to 16 bits to ensure precision in processing in a later stage (e.g. the developing unit 219) and output the digital data. The data obtained by converting signals output by the imaging sensor in this way is referred to as RAW data. The RAW data is developed in the developing unit 219 in a later stage.

The timing generator generates a signal for adjusting the timing of the imaging sensor 208 and the timing of the developing unit 219 in the later stage.

In the case where a CCD is used as the image pickup sensor 208, the above-described AFE 209 is indispensable. On the other hand, in the case where a CMOS image sensor capable of outputting digital signals is used, the CMOS image sensor itself has the above-described function of the AFE 209. There is also provided an imaging controller that controls the imaging sensor 208, though not shown in the drawings. The imaging controller controls timing and operations of the imaging sensor 208 such as the shutter speed, the frame rate, and the region of interest (ROI) etc.

The developing unit 219 includes a black correction unit 211, a demosaicing unit 212, a white balance adjusting unit 213, an image composing unit 214, a filter processing unit 216, a gamma correction unit 217, and a compression processing unit 218.

The black correction unit 211 performs processing of subtracting black correction data obtained in the shaded state from the RAW data for each pixel.

The demosaicing unit 212 performs processing of generating image data of respective colors of red (R), green (G), and blue (B) from the RAW data of the Bayer arrangement. The demosaicing unit 212 calculates the respective values of red, green, and blue in a target pixel by performing interpolation using the values in the pixels (including pixels of the same color and pixels of different colors) in the vicinity of the target pixel in the RAW data. The demosaicing unit 212 also performs correction processing (or interpolation) for defective pixels.

In the case where the imaging sensor 208 does not have a color filter and picks up a monochromatic image, the demosaicing processing is not needed, and the demosaicing unit 212 performs the correction processing for defective pixels.

The white balance adjusting unit 213 performs processing of adjusting the gains for the respective colors of red, green, and blue in accordance with the color temperature of the illumination unit 201 to reproduce desirable white. In the case where a monochromatic image is processed, the white balance adjusting processing is not needed.

The imaging apparatus 101 according to this embodiment divides an area to be imaged (i.e. the area over which the slide exists) into small regions each having a size over which the imaging sensor 208 can capture an image by a single imaging session and performs imaging for the small regions on a region-by-region basis. The image composing unit 214 performs processing of stitching a plurality of images captured by the above-described divisional imaging to generate a large size image data representing the entire area to be imaged (i.e. the entirety of the slide). In this embodiment, it is assumed that the size of the entire area to be imaged is larger than the size of the region over which the image sensor can capture an image by a single imaging session. Thus, the imaging apparatus 101 generates data of a single two-dimensional image in which the entire area to be imaged (or the entirety of the slide) is taken by performing processing of stitching a plurality of images captured by divisional imaging.

Here, it is assumed for example that a square area of 10 mm×10 mm on the slide 206 is to be imaged at a resolution of 0.25 μm. Then, the number of pixels along one side of the area is 10 mm/0.25 μm=40,000, and hence the total number of pixels is 40,000²=1,600,000,000 (16 hundred-million). If the number of pixels of the imaging sensor 208 is 10 mega (10 million) pixels, in order to obtain image data of hundred-million pixels, it is necessary to divide the entire area to be imaged (the entirety of the slide) into (16 hundred-million)/(10 million)=160 divisional regions and to perform imaging for the respective divisional regions.

Exemplary methods of stitching data of a plurality of images include stitching the plurality of divisional images while aligning them based on information about the position of the stage 202, stitching the plurality of divisional images with reference to corresponding points or lines in the divisional images, and stitching the plurality of divisional images based on positional information of the divisional images. Using interpolation processing such as 0-th order interpolation, linear interpolation, or high-order interpolation in stitching the images can lead to smoother stitching. In this embodiment, it is assumed that a single image having a large data amount is generated by the imaging apparatus 101. However, the image processing apparatus 102 may perform the processing of stitching divisional images captured by divisional stitching by the imaging apparatus 101 to generate a single image having a large data amount.

The filter processing unit 216 is a digital filter that performs processing of reducing high frequency components contained in the image, removing noises, and increasing the apparent sharpness.

The gamma correction unit 217 performs processing of giving inverse characteristics to the image taking into consideration tone reproduction characteristics of common display devices and performs tone conversion adapted to characteristics of human eyesight by tone compression in the high luminance part and/or dark part processing. In this embodiment, in order to produce an image to be used for the purpose of morphological observation, tone conversion suitable for composing processing and display processing in later stages is applied to the image data°

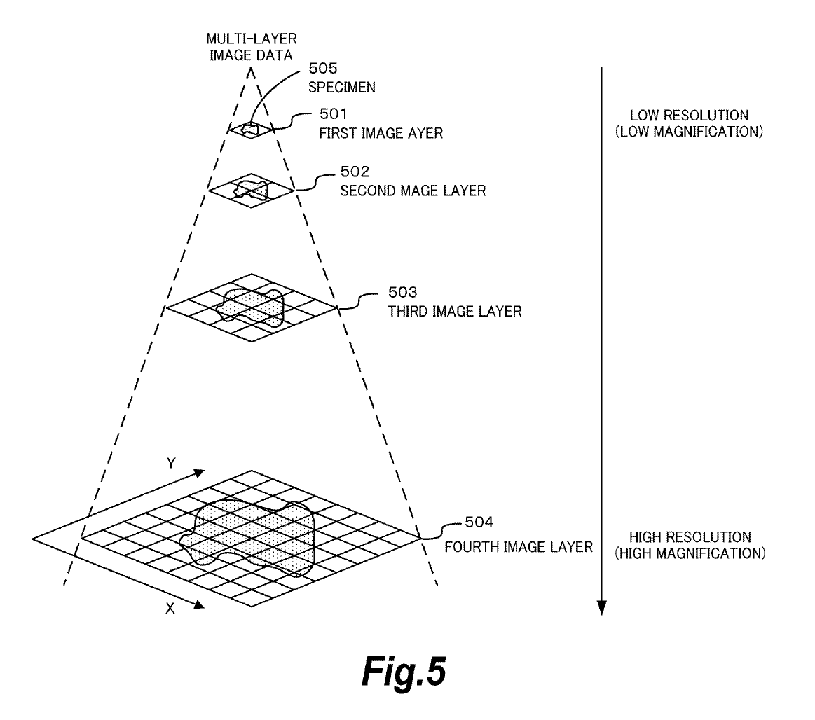

The compression processing unit 218 performs compression encoding in order to improve efficiency of transmission of large size two-dimensional image data and to reduce data amount for storage. As compression method for still images, standardized encoding scheme such as JPEG (Joint Photographic Experts Group), and JPEG2000 and JPEG XR developed by improving or advancing JPEG are widely known. The compression processing unit 218 also performs processing of reducing two-dimensional image data and generates multi-layer image data. The multi-layer image data will be described later with reference to FIG. 5.

The preliminary measurement unit 220 is a unit that performs measurement for obtaining information about the position of a specimen on the slide 206 and information about the distance to a desired focus position and for calculating a parameter used for light quantity adjustment in accordance with the thickness of the specimen. This measurement is preliminary measurement performed before imaging (or main measurement) of acquiring virtual slide image. By obtaining the information about the object of imaging (i.e. the slide) by the preliminary measurement unit 220 before main measurement, imaging can be performed efficiently. A two-dimensional imaging sensor having a resolving power lower than the imaging sensor 208 is used to obtain position information in a two-dimensional plane. The preliminary measurement unit 220 obtains information about the position of the specimen on the X-Y plane from a captured image. A laser displacement meter or a Shack-Hartmann sensor is used to obtain distance information and thickness information.

The main control system 221 is configured to control the units described in the foregoing. The control functions of the main control system 221 and the developing unit 219 are implemented in a control circuit having a CPU, a ROM (Read-Only Memory), and a RAM. Specifically, programs and data are stored in the ROM, and the functions of the main control system 221 and the developing unit 219 are carried out by the CPU that executes the programs while using the RAM as a work memory.

As the ROM, a device such as an EEPROM (Electronically Erasable and Programmable Read-Only Memory) or a flash memory is used. As the RAM, a DRAM (Dynamic RAM) device such as a DDR3 DRAM is used for example. Alternatively, the function of the developing unit 219 may be implemented in an ASIC (Application Specific Integrated Circuit) as a dedicated hardware device.

The external apparatus I/F 222 is interface for transmission of the multi-layer image data generated by the developing unit 219 to the image processing apparatus 102. The imaging apparatus 101 and the image processing apparatus 102 are connected by an optical communication cable. Alternatively, general-purpose interface such as USB or Gigabit Ethernet (registered trademark) is used to connect the imaging apparatus 101 and the image processing apparatus 102.

### (Hardware Configuration of the Image Processing Apparatus)

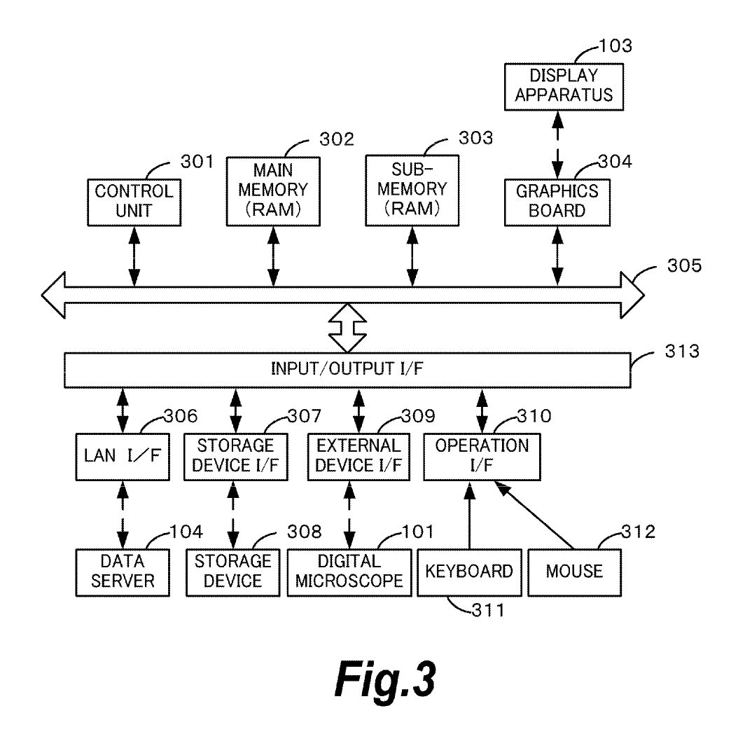

FIG. 3 is a block diagram showing the hardware configuration of the image processing apparatus 102 according to the present invention.

The apparatus performing the image processing may be, for example, a personal computer (PC). The PC has a control unit 301, a main memory 302, a sub-memory 303, a graphics board 304, an internal bus 305 for interconnecting the above-mentioned units, LAN I/F 306, storage device I/F 307, external device I/F 309, operation I/F 310, and input/output I/F 313.

The control unit 301 accesses the main memory 302 and the sub-memory 303 when needed and performs overall control of all the blocks of the PC while executing various computations.

The main memory 302 and the sub-memory 303 are constituted by RAMs. The main memory 302 serves as a working area for the control unit 301, temporarily storing various data processed by the OS, various programs under execution, and display data generation. The main memory 302 and the sub-memory 303 also serve as storage areas for image data. The DMA (Direct Memory Access) function of the control unit 301 enables high-speed transmission of image data between the main memory 302 and the sub-memory 303 and between the sub-memory 303 and the graphics board 304.

The graphics board 304 outputs the result of image processing to the display apparatus 103. The display apparatus 103 is a display device utilizing, for example, liquid crystal or EL (Electro-Luminescence). In this embodiment, the display apparatus 103 is an external apparatus connected to the image processing apparatus 102. However, the image processing apparatus and the display apparatus may be constructed as a single integrated apparatus. A notebook PC can constitute such an integrated apparatus.

To the input/output I/F 313 are connected the data server 104 via the LAN I/F 306, a storage device 308 via the storage device I/F 307, the imaging apparatus 101 via the external device I/F 309, and a keyboard 311 and a mouse 312 via the operation I/F 310. The imaging apparatus 101 is, for example, a virtual slide scanner or a digital microscope.

The storage device 308 is an auxiliary storage device, which permanently store the OS and programs to be executed by the control unit 301 and various parameters as firmware. The data and information stored in the storage device 308 can be read out via the storage device I/F 307. The storage device 308 also serves as a storage area for multi-layer image data sent from the imaging apparatus 101. As the storage device 308, a magnetic disk drive such as a HDD (Hard Disk Drive) or SSD (Solid State Drive) or a semiconductor device using a flash memory may be used.

Pointing devices such as the keyboard 311 and the mouse 312 have been mentioned as input devices connected to the operation I/F 310 by way of example, the screen of the display apparatus 103 can be adapted to constitute an input device for example by the use of a touch panel or the like. When this is the case, the touch panel serving as an input device is integrated with the display apparatus 103.

### (Functional Blocks of the Control Unit of the Image Processing Apparatus)

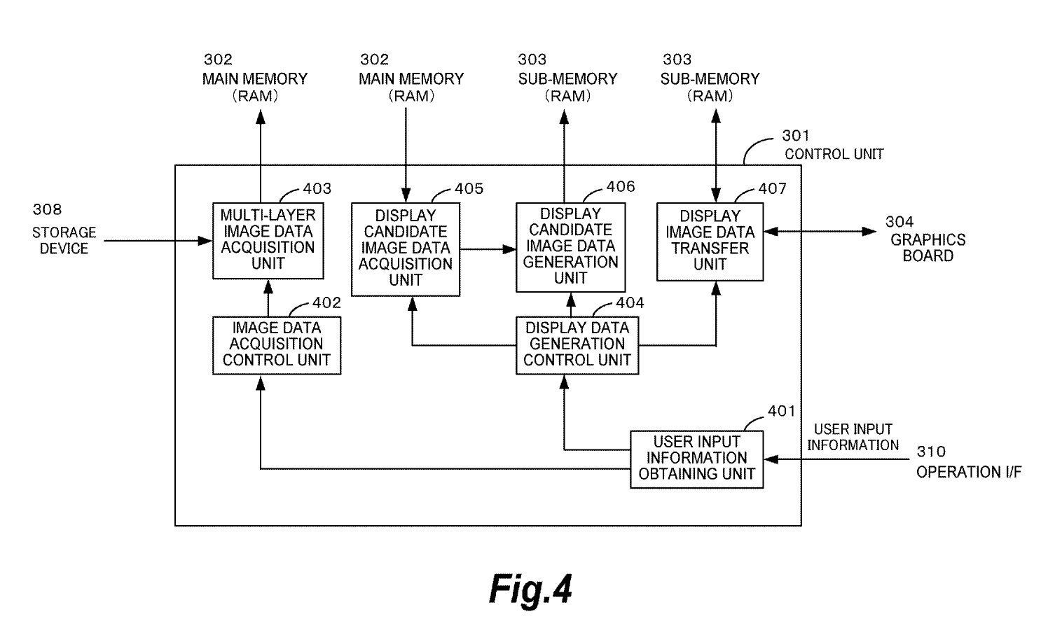

FIG. 4 is a block diagram showing the functional configuration of the control unit 301 of the image processing apparatus according to the present invention.

The control unit 301 is composed of a user input information obtaining unit 401, image data acquisition control unit 402, a multi-layer image data acquisition unit 403, a display data generation control unit 404, a display candidate image data acquisition unit 405, a display candidate image data generation unit 406, and a display image data transfer unit 407.

The user input information obtaining unit 401 obtains command information input by the user through the keyboard 311 and/or the mouse 312 via the operation I/F 310. Examples of the command information include start and termination of image display, and scroll, reduction, and magnification of the display image.

The image data acquisition control unit 402 controls, based on information input by the user, read-out of image data from the storage device 308 and development of the image data into the main memory 302. The image data acquisition control unit 402 estimates changes of the displayed region (i.e. the image region to be actually displayed on the display apparatus) on the basis of various user input information such as start and termination of image display, and scroll, reduction, and magnification of the display image. Then, the image data acquisition control unit 402 specifies an image area (first display candidate region) the image data of which is needed to generate an image of the displayed region.

If the main memory 302 is not holding image data of the first display candidate region, the image data acquisition control unit 402 instructs the multi-layer image data acquisition unit 403 to read out image data of the first display candidate region from the storage device 308 and to develop the read-out image data into the main memory 302. Because the read-out of the image data from the storage device 308 takes processing time, it is desirable that the first display candidate region be set to be as large as possible to reduce the overhead necessitated by this processing.

The multi-layer image data acquisition unit 403 reads out image data from the storage device 308 and develops the read-out image data into the main memory 302 according to control instructions by the image data acquisition control unit 402.

The display data generation control unit 404 controls read-out of image data from the main memory 302, processing of the read-out image data, and transfer of the image data to the graphics board 304 on the basis of information input by the user. The display data generation control unit 404 estimates changes of the displayed region on the basis of user input information such as start and termination of image display, and scroll, reduction, and magnification of the display image. Moreover, the display data generation control unit 404 specifies an image region (a second display candidate region) whose image data is needed in generating the image of the displayed region and an image region (displayed region) to be actually displayed on the display apparatus 103.

If the sub-memory 303 is not holding the image data of the second display candidate region, the display data generation control unit 404 instructs the display candidate image data acquisition unit 405 to read out the image data of the second display candidate region from the main memory 302. Furthermore, the display data generation control unit 404 instructs the display candidate image data generation unit 406 as to the image data processing method responsive to a scroll request.

The display data generation control unit 404 instructs the display image data transfer unit 407 to read out the image data of the displayed region from the sub-memory 303. The read-out of image data from the main memory 302 can be done at a speed higher than the read-out of image data from the storage device 308. Therefore, the area of the second display candidate region may be set smaller than the area of the above-mentioned first display candidate region. Thus, the relationship of the areas of the above-mentioned first display candidate region, second display candidate region, and displayed region is as follows: the first display candidate region ≧ the second display candidate region ≧ the displayed region.

The display candidate image data acquisition unit 405 reads out the image data of the second display candidate region from the main memory 302 and transfers the read-out image data to the display candidate image data generation unit 406 according to control instructions by the display data generation control unit 404.

The display candidate image data generation unit 406 executes decompression of the compressed image data of the display candidate region to develop the image data into the sub-memory 303.

The display image data transfer unit 407 reads out the image data of the displayed region from the sub-memory 303 and transfers the read-out image data to the graphics board 304 according to control instructions by the display data generation control unit 404. The DMA function enables high-speed transmission of image data between the sub-memory 303 and the graphics board 304.

### (Structure of Multi-Layer Image Data)

FIG. 5 schematically illustrates the structure of multi-layer image data. It is assumed that the multi-layer image data is composed of four layers of image data having different resolutions (i.e. different numbers of pixels), namely, a first image layer 501, a second image layer 502, a third image layer 503, and a fourth image layer 504. The number of layers is not limited to that in this illustrative case. A specimen 505 is a slice of tissue or a smear of cells to be observed. In FIG. 5, the same specimen 505 is illustrated in different sizes in the respective layers of images to facilitate the understanding of the layered structure.

The first image layer 501 is an image having the lowest resolution among the four image layers, which is used as a thumbnail image or the like. The second image layer 502 and the third image layer 503 are images having medium resolutions, which are used for large-area observation of the virtual slide image. The fourth image layer 504 is an image having the highest resolution, which is used when the virtual slide image is observed in detail.

Each image layer is constituted by a collection of a certain number of blocks of compressed images. For example, in the case of JPEG compression, each compressed image block is a single JPEG image. In the illustrated case, the first image layer 501 is composed of one compressed image block, the second image layer 502 is composed of four compressed image blocks, the third image layer 503 is composed of 16 (sixteen) compressed image blocks, and the fourth image layer 504 is composed of 64 (sixty-four) compressed image blocks.

Differences in the resolution are analogous to differences in the optical magnification in the microscope observation. Specifically, observation of the first image layer 501 displayed on the display apparatus corresponds to microscope observation at a low magnification, and observation of the fourth image layer 504 displayed on the display apparatus corresponds to microscope observation at a high magnification. For example, if the user wishes to observe a specimen in detail, he/she may cause the display apparatus to display the fourth image layer 504 for observation.

### (Slide)

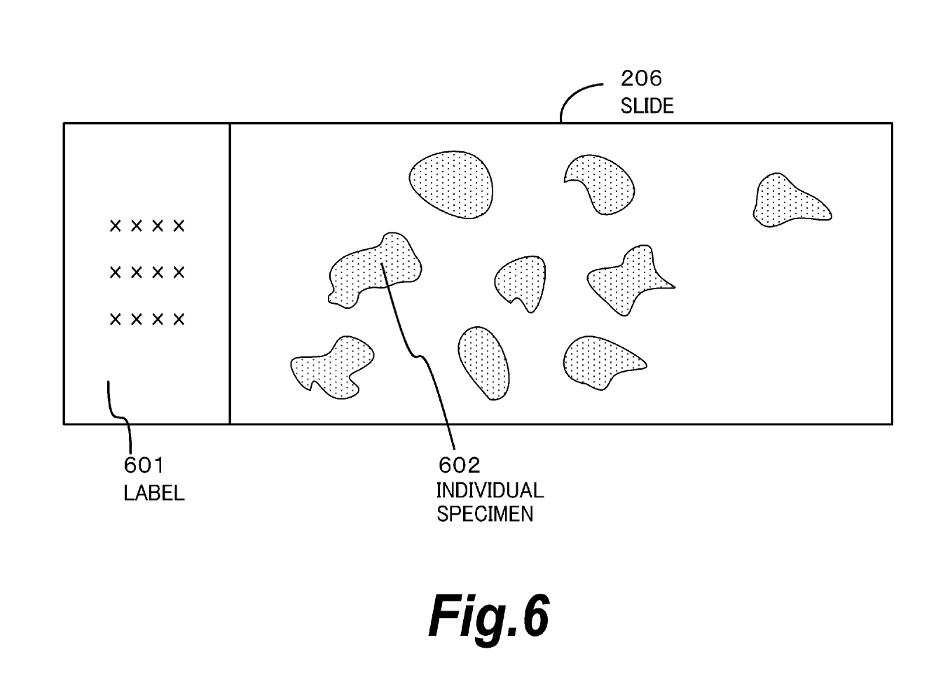

FIG. 6 is a schematic diagram of a slide on which a plurality of specimens are placed. The slide 206 is a piece prepared by placing a plurality of specimens on a slide glass and fixing it under a cover glass with mounting agent. The slide 206 has a label 601 indicating identification information of the specimens. Information written on the label 601 includes an identification number for identifying a patient, information identifying a body part such as stomach, liver, large intestine, and small intestine from which the specimen was sampled, the name of the facility in which the slide was prepared, and comment for facilitating observation etc.

In the illustrated case, nine specimens are attached to the slide 206, and an individual specimen 602 is one of the specimens. In the case of biopsy (removal of tissue for diagnostic examination from a living body) of stomach, liver or the like, a plurality of specimens are placed on one slide in some cases, as shown in FIG. 6. The application of the present invention is not limited to cases where there are a plurality of specimens on one slide, but the present invention can also be applied to cases where there is only one specimen on one slide. In any case, the present invention provides advantageous effects, which will be describer later.

### Exemplary Screen of Image Presentation Application

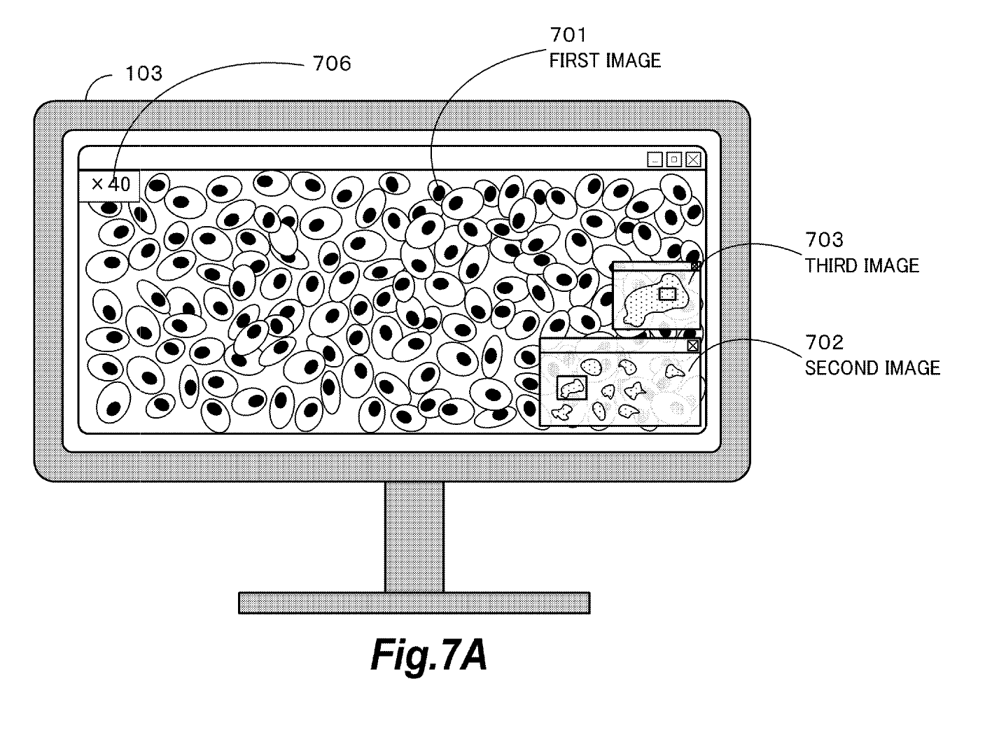

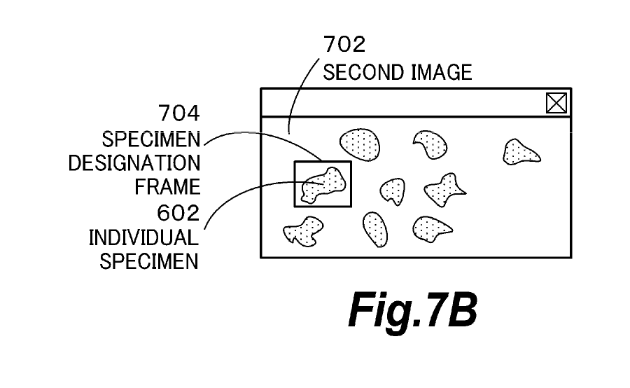

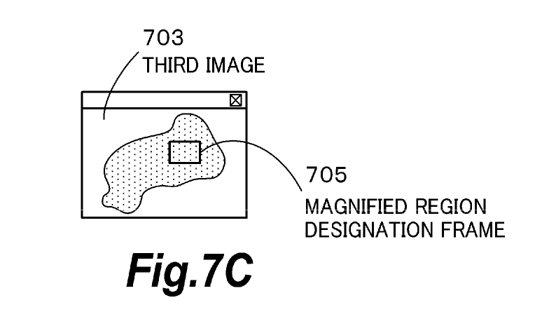

FIGS. 7A, 7B, and 7C show an exemplary screen of an application for presenting a virtual slide image. The program of the image presentation application is stored in the storage device 308 of the image processing apparatus 102. The function of the image presentation application is implemented by the control unit 301 by reading the program from the storage device 308, developing it into the memory, and executing it. The image presentation application generates display data for image presentation, using the multi-layer image data and GUI data retrieved from the storage device 308 and outputs the display data to the display apparatus 103 through the graphics board 304. Thus, an application screen for image presentation is displayed on the display apparatus 103. How the image presentation application is executed is not limited to the process described above.

For example, the image processing apparatus 102 may be equipped with a dedicated hardware for implementing the function of the image presentation application. Alternatively, an extension board equipped with such hardware may be attached to the image processing apparatus 102 to enable the image processing apparatus 102 to execute the image presentation application. The source from which the image presentation application is provided is not limited to an external storage device, but the image presentation application may be downloaded through a network.

FIG. 7A shows the overall layout of an application screen displayed on the screen of the display apparatus 103. The application screen includes three windows, in which a first image 701, a second image 702, and a third image 703 are displayed respectively.

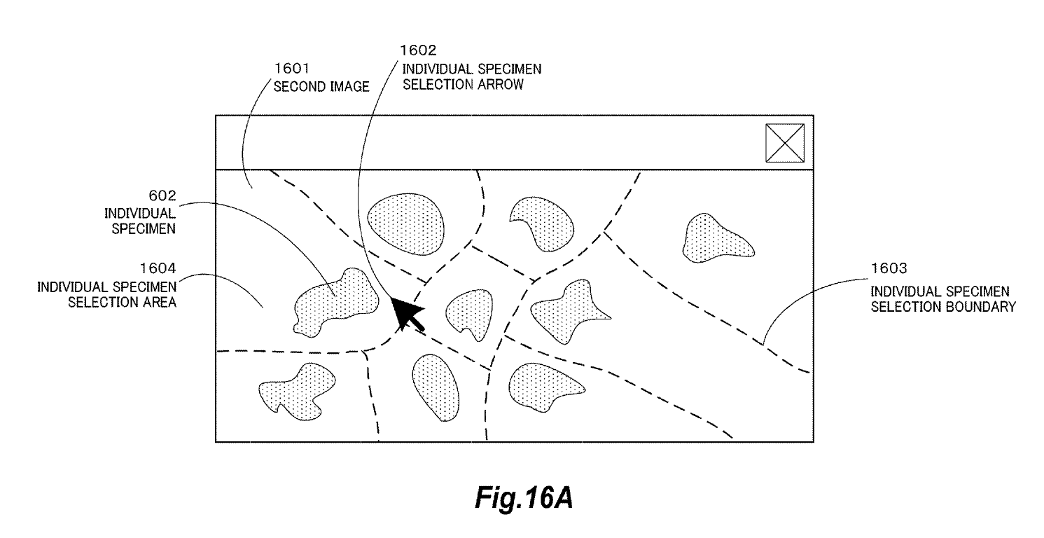

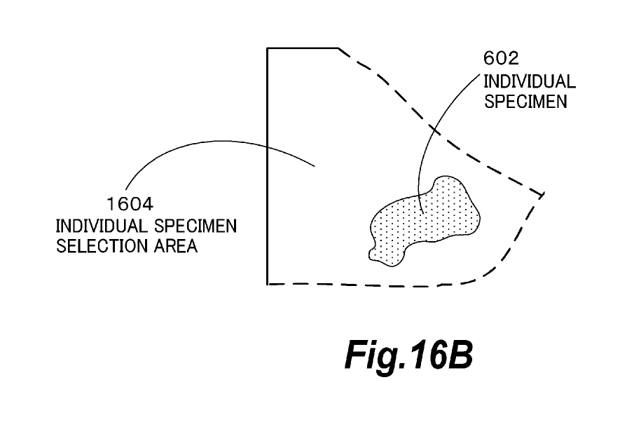

FIG. 7B shows the window in which the second image 702 is displayed. The second image 702 is an image (slide image) acquired by imaging the portion of the slide 206 other than the label 601. When there are a plurality of specimens on the slide 206, the user can see all the specimens attached to the slide in the window in which the second image 702 is displayed. In the window in which the second image 702 is displayed, the user can select one specimen (individual specimen) from among the plurality of specimen appearing in the second image 702. In the illustrative case shown in FIG. 7B, an individual specimen 602 is selected. The selected individual specimen is highlighted by a specimen designation frame 704. The process for selecting an individual specimen in the window in which the second image 702 is displayed will be described later (see FIG. 16).

FIG. 7C shows the window in which the third image 703 is displayed. The third image 703 is a magnified image (individual specimen image) of the individual specimen 602 selected in the second image 702. In the window in which the third image 703 is displayed, the user can specify a region which he/she wishes to display in a magnified manner as the first image 701. The specified region (magnified region) is highlighted by a magnified region designation frame 705.

In FIG. 7A, the window in which the second image 702 is displayed, the window in which the third image 703 is displayed, and the information 706 about the magnification are displayed in the window in which the first image 701 is displayed in a superposed manner. The first image 701 is a magnified image of the region in the individual specimen 602 selected in the second image 702, designated by the magnified region designation frame 705 in the third image 703. The first image 701 is used for detailed observation of the specimen.

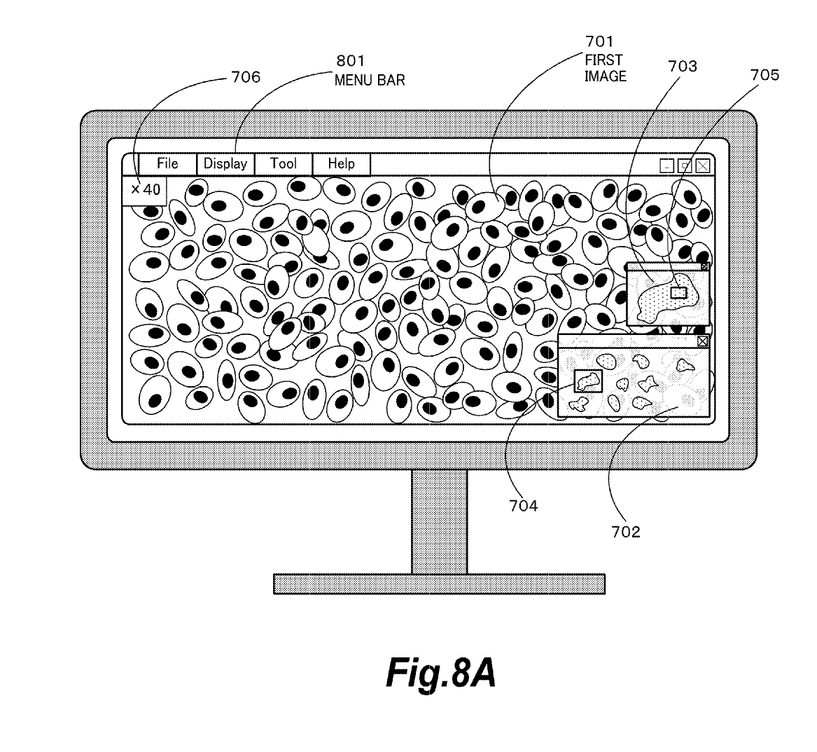

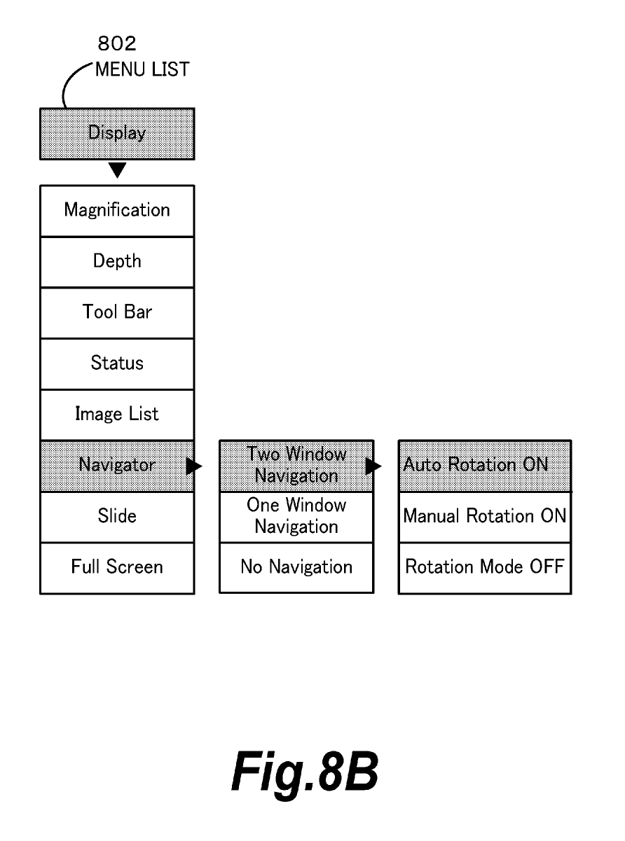

The second image 702 and the third image 703 can be considered to be a base image and a derivative image, which are in a first reduction-magnification relationship. The third image 703 and the first image 701 can also be considered to be a base image and a derivative image, which are in a second reduction-magnification relationship. This way of image presentation enables efficient observation of the specimen. Important features of the way of image presentation according to the present invention will be described below with reference to FIGS. 8A and 8B and other drawings.

### (Setting of Image Presentation Application)

FIGS. 8A and 8B are schematic diagrams illustrating setting of the image presentation mode in the image presentation application.

FIG. 8A shows the overall layout of an application screen displayed on the screen of the display apparatus 103. FIG. 8A is similar to FIG. 7A but shows a menu bar 801 to illustrate setting of the image presentation mode. The menu bar 801 contains four menus, which are “File”, “Display”, “Tool”, and “Help”. The setting of the image presentation mode is performed using the “Display” menu. The menus described here are exemplary ones, and the present invention is not limited by them.

FIG. 8B shows a menu list 802 of the “Display” menu in FIG. 8A. FIG. 8B shows eight menus including “Magnification”, “Depth”, “Tool bar”, “Status”, “Image List”, “Navigator”, “Slide”, and “Full-Screen” in the first layer of the “Display” menu by way of example.

The “Magnification” and “Depth” menus are used to set whether or not to display information about the magnification and the depth of the image presented as the first image 701. In the exemplary screen shown in FIG. 8A, while the text “×40” 706 is displayed as magnification information in the first image 701 in a superposed manner, depth information is not displayed.

The “Tool Bar” menu is used to set whether or not to display a tool bar that contains tools for copying, cutting, and pasting images.

The “Status” menu is used to set whether or not to display a status panel for displaying information about the image format, coordinate information of the position designated by a mouse pointer on the image etc.

The “Image List” menu is used to set whether or not to display an image list for displaying a list of image files in the folder.

The “Navigator” menu will be described below.

The “Slide” menu is used to set whether or not to display an entire image of the slide including label captured by the preliminary measurement.

The “Full-Screen” menu is used to set whether or not to display the first image 701 as the full-screen in the screen of the display apparatus 103.

The “Navigator” menu is used to set whether or not to display the second image 702 and the third image 703 as navigation screens. The “Navigator” menu has lower menu layer including “Two Window Navigation”, “One Window Navigation”, and “No Navigation”.

When “Two Window Navigation” is selected, the image presentation is performed in the mode in which the second image 702 (image of the slide) and the third image 703 (image of an individual specimen) are displayed in addition to the first image 701 (magnified image), as is the case with the exemplary screen shown in FIG. 8A.

When “One Window Navigation” is selected, the image presentation is performed in the mode in which the second image 702 (image of the slide) is displayed in addition to the first image 701 (magnified image). In this mode, the specimen designation frame 704 is not displayed in the second image 702, and only the magnified region designation frame 705 is displayed. In this case, the designation of the region to be displayed as the first image 701 is performed using the second image 702. The image presentation application may be configured in such a way that both the specimen designation frame 704 and the magnified region designation frame 705 are displayed in the second image 702. Such configuration will be described later in the third embodiment.

When “No Navigation” is selected, only the first image 701 is displayed, and the screens of the second image 702 and the third image 703 are not displayed.

The “Two Window Navigation” has a further lower layer including three setting items, which are “Auto-Rotation ON”, “Manual Rotation ON” and “Rotation Mode OFF”.

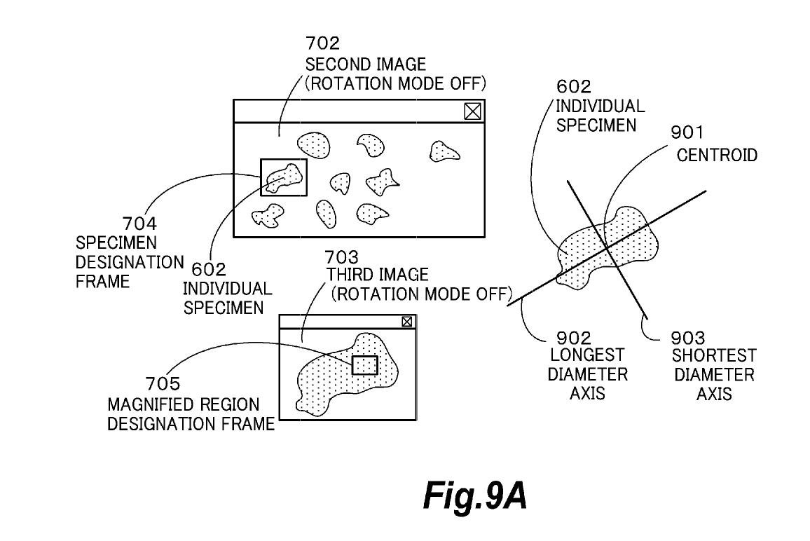

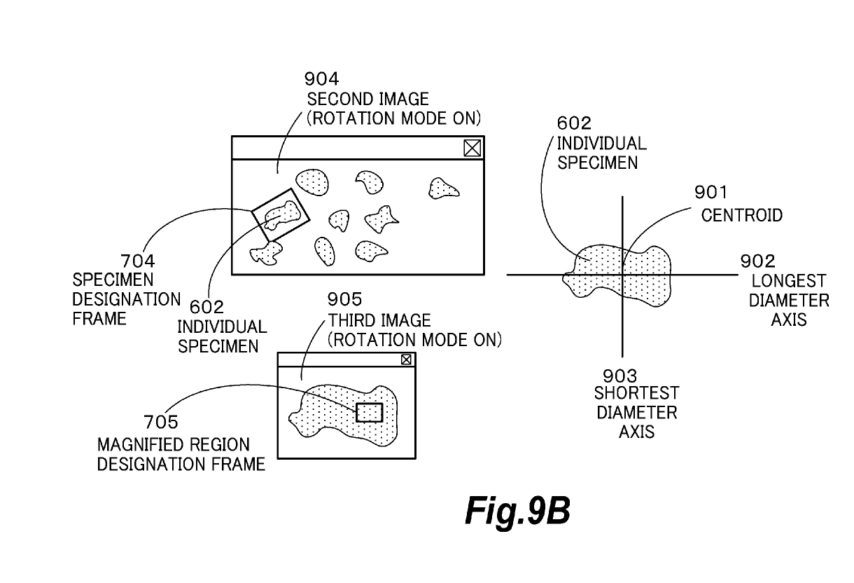

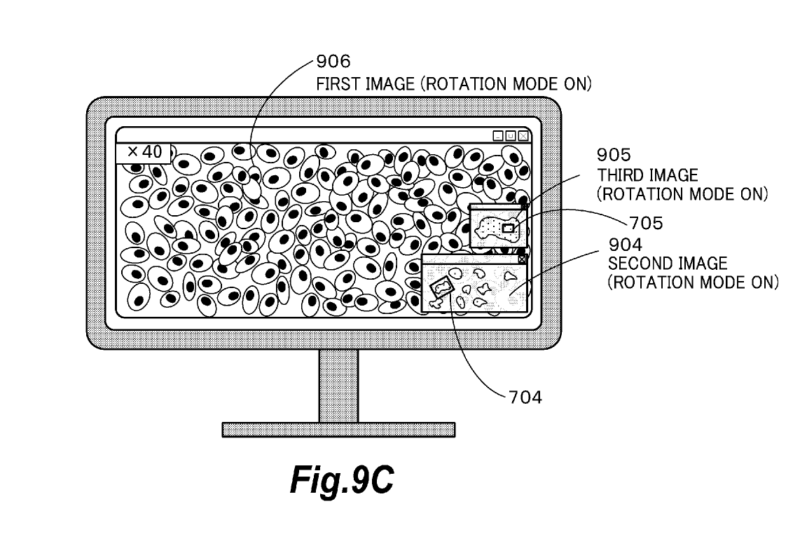

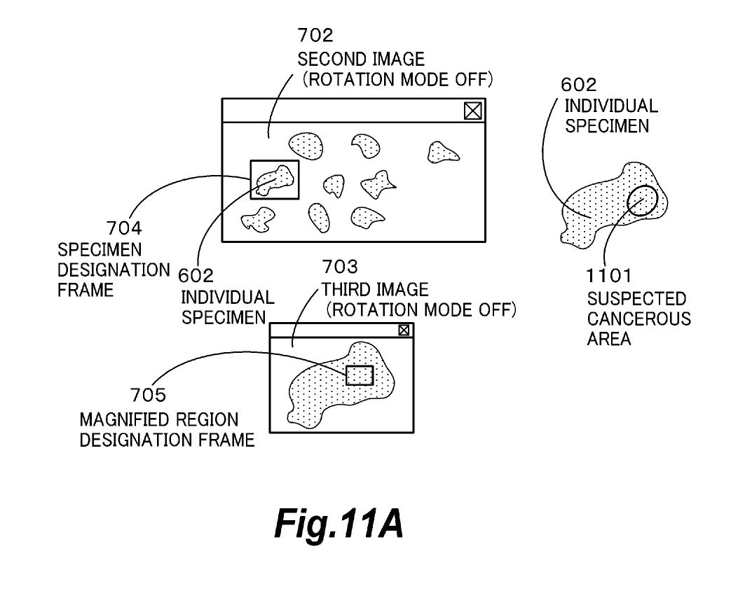

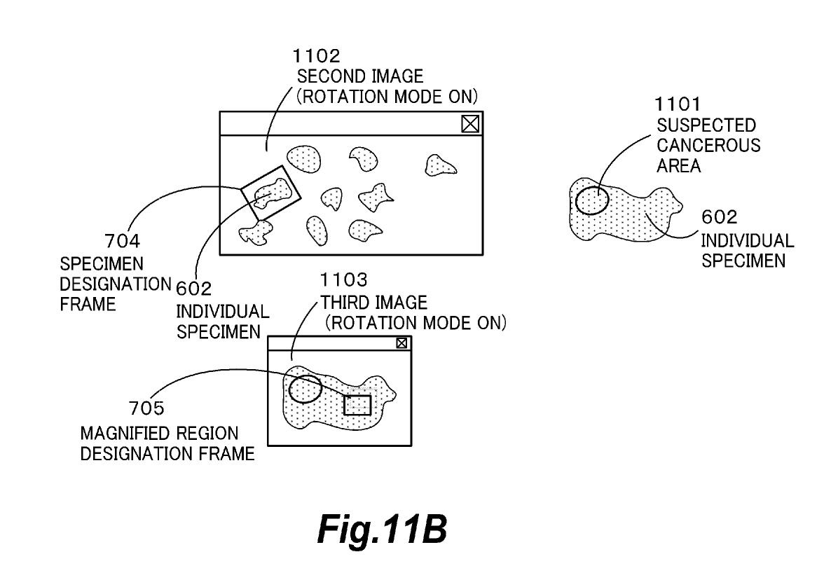

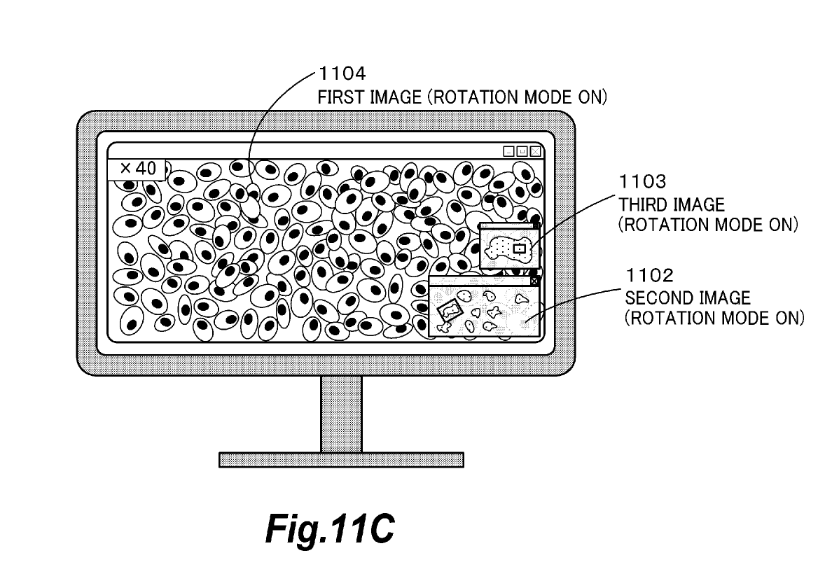

When “Auto-Rotation ON” or “Manual Rotation ON” is selected, the first image (magnified image), the specimen designation frame in the second image, and the third image (image of an individual specimen) are displayed in a rotated state according to the shape or condition of the individual specimen or according to a rotating operation made by the user. The above-mentioned “Auto-Rotation ON” and “Manual Rotation ON” are collectively referred to as “Rotation Mode ON”. This will be described in detail later with reference to FIGS. 9 and 11.

When “Rotation Mode OFF” is selected, the image presentation is performed without applying image rotation to the multi-layer image data received from the imaging apparatus 101 as shown in FIGS. 7A to 7C.

FIG. 8B shows an exemplary display of the menu GUI (Graphical User Interface) in a case where “Navigator”, “Two Window Navigation”, and “Auto-Rotation ON” are selected in the “Display” menu. An illustrative Application screen display with the setting of the “Display” menu shown in FIG. 8B will be described below with reference to FIGS. 9A, 9B, and 9C. The interface used to set the image presentation mode in the image presentation application is not limited to the GUI menu having the above-described configuration.

### (Image Rotation Based on Specimen Shape)

FIGS. 9A, 9B, and 9C are schematic diagrams illustrating image rotation and image presentation based on specimen information (specimen shape). While FIG. 9A shows an exemplary image presentation in a case where the rotation mode is OFF, FIG. 9B shows an exemplary image presentation in a case where the rotation mode is ON.

FIG. 9A shows an exemplary image presentation in a case where the rotation mode is OFF. FIG. 9A shows the window in which the second image 702 is displayed (with the rotation mode OFF), the window in which the third image 703 is displayed (with the rotation mode OFF), and the individual specimen 602.

On the other hand, in the case of the image presentation with the rotation mode ON, a rotated image of the individual specimen 602 is displayed as the third image 703. The rotation of the image of the individual specimen 602 is performed based on the shape of the individual specimen 602. In FIG. 9A, the figure of the individual specimen 602 on the right of the second image 702 and the third image 703 illustrates exemplary information representing the shape of the individual specimen 602. In the illustrated case, the information representing the shape of the individual specimen 602 includes the geometric centroid 901, the longest diameter axis 902, and the shortest diameter axis 903 of the individual specimen 602. Here, the longest diameter axis is defined as an axis that passes through the geometric centroid of the individual specimen and along which the diameter of the individual specimen is longest. The shortest diameter axis is defined as an axis that passes through the geometric centroid of the individual specimen and along which the diameter of the individual specimen is shortest.

FIG. 9B shows an exemplary image presentation in a case where the rotation mode is ON. FIG. 9B shows the window in which the second image 904 is displayed (with the rotation mode ON), the window in which the third image 905 is displayed (with the rotation mode ON), and the individual specimen 602. What differs in FIG. 9B from FIG. 9A is that the display image of the individual specimen 602 in the third image 905 is rotated about the geometric centroid 901 in such a way that the longest diameter axis 902 is oriented horizontal in the window. In the illustrated case, since the longest diameter axis and the shortest diameter axis are perpendicular to each other, it can also be said that the display image of the individual specimen 602 in the third image 905 is rotated about the geometric centroid 901 in such a way that the shortest diameter axis 903 is oriented vertical in the window.

The third image 905 (with the rotation mode ON) is an image of the individual specimen 602 rotated in the above-described manner. In the second image 904 (with the rotation mode ON), the specimen designation frame 704 is rotated in accordance with the rotation of the individual specimen 602 in the third image 905. The magnified region designation frame 705 appearing in the third image 905 (with the rotation mode ON) has a frame shape the same as the magnified region designation frame 705 in FIG. 9A. However, since the individual specimen 602 in the third image 905 is rotated, the magnified region designated by the frame in FIG. 9A and the magnified region designated by the frame in FIG. 9B are different from each other.

FIGS. 9A and 9B show a particular case in which the longest diameter axis and the shortest diameter axis of the individual specimen 602 are perpendicular to each other. There will also be cases where the individual specimen has a shape in which the longest diameter axis and the shortest diameter axis are not perpendicular to each other. In such cases, the image of the individual specimen may be rotated with reference to only one of the longest and shortest diameter axes. For example, the individual specimen in the third image may be rotated in such a way that the longest diameter axis is oriented horizontal or vertical in the window or in such a way that the shortest diameter axis is oriented horizontal or vertical in the window.

FIG. 9C shows an exemplary screen of the image presentation application in a case where the rotation mode is ON. The first image 906 (with the rotation mode ON), the second image 904 (with the rotation mode ON), and the third image 905 (with the rotation mode ON) reflect the rotation effected in the case shown in FIG. 9B, where the rotation mode is ON. Thus, what is displayed in the screen shown in FIG. 9C is different from that in FIG. 7A. What differs in FIG. 9C from FIG. 7A is that the individual specimen 602 in the third image 905 (with the rotation mode ON) is rotated and that the specimen designation frame 704 in the second image 904 (with the rotation mode ON) is rotated. The magnified region (the region of the individual specimen displayed in the magnified manner) displayed in the first image 701 in FIG. 7A and the magnified region displayed in the first image 906 (with the rotation mode ON) in FIG. 9C are different from each other, though the schematic illustrations in FIGS. 7A and 9C do not show the difference specifically.

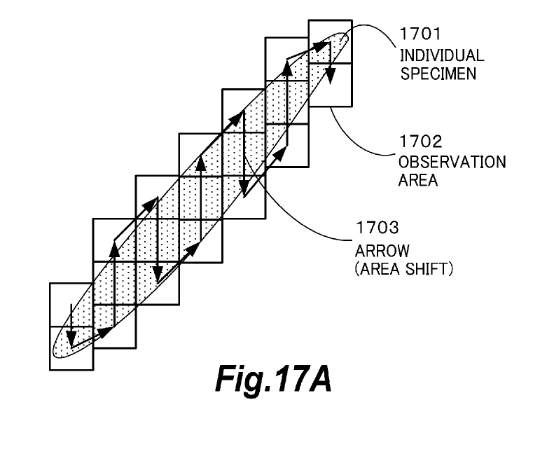

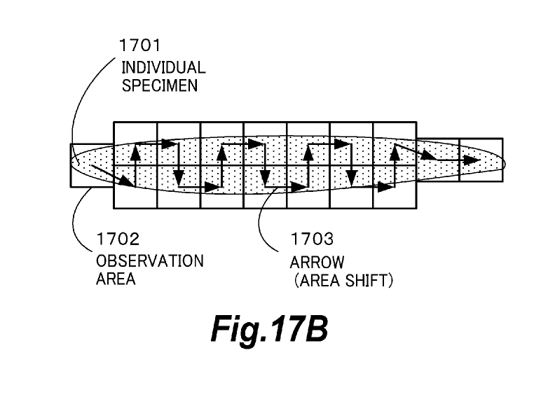

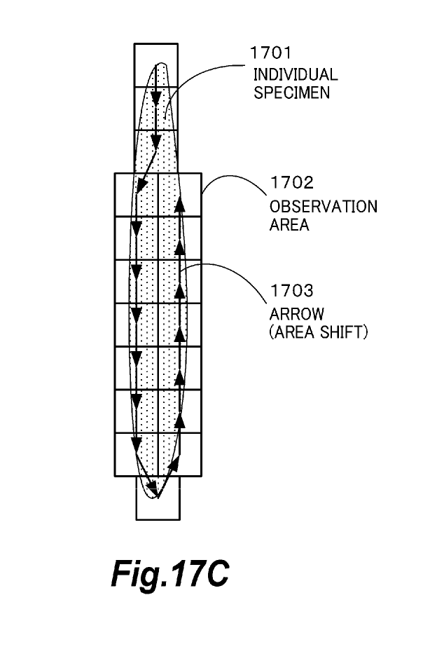

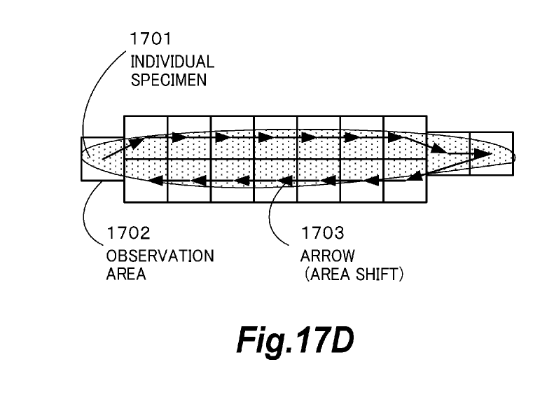

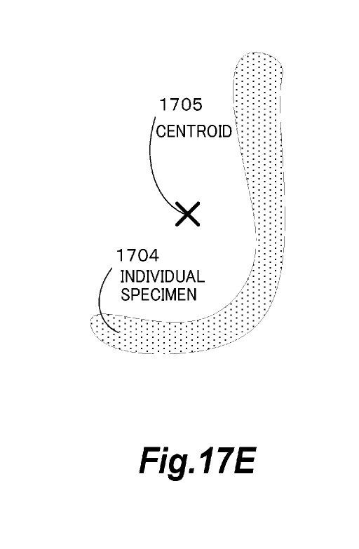

The rotation of the first image, the third image, and the frame in the second image specifying a region in the third image effected based on the shape of the specimen as shown in FIG. 9B can lead to a reduction in the burden on the user in observing (or screening) the specimen. Specific advantageous effects will be described later (see FIG. 17A to 17E).

### (Process of Image Rotation Based on Specimen Shape)

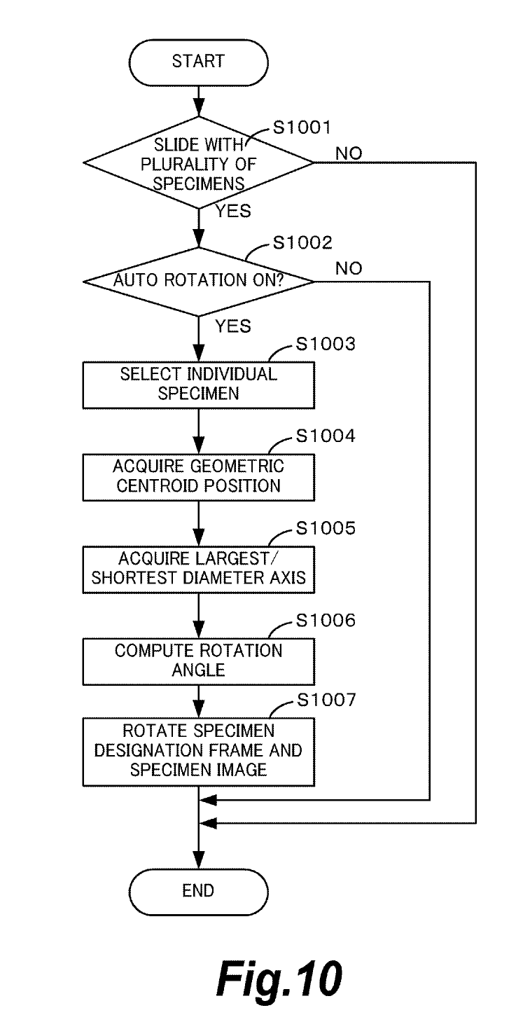

FIG. 10 is a flow chart of a process of image rotation based on specimen information (shape). The process of this flow chart is executed by the control unit 301 of the image processing apparatus 102, which executes the image presentation application.

In step S1001, the control unit 301 makes a determination as to whether or not there are a plurality of specimens on the slide 206. This step is executed in the preliminary measurement. For instance, information about the number of specimens is written or electronically recorded on the label 601 beforehand at the time of preparation of the slide 206, and the information on the label 601 is read in the preliminary measurement to acquire the information about the number of specimens.

The information about the number of specimen is stored and held in the imaging apparatus 101, the storage device 308, or an apparatus in the network. The control unit 301 of the image processing apparatus 102 retrieves the information about the number of specimens from the imaging apparatus 101, the storage device 308, or the apparatus in the network and makes a determination as to whether or not there are a plurality of specimens on the slide 206 on the basis of this information.

Alternatively, an image of the slide 206 captured by imaging in the preliminary measurement may be stored and held in the imaging apparatus 101, the storage device 308, or an apparatus in the network. In this case, the control unit 301 of the image processing apparatus 102 may retrieve the image of the slide 206 from the imaging apparatus 101, the storage device 308, or the apparatus in the network and determine the number of specimen by image processing.

In step S1002, the control unit 301 makes a determination as to whether or not auto-rotation is set to ON in the image presentation mode setting of the image presentation application. Auto-rotation can be set to ON by the user with the display menu described above with reference to FIG. 8. As the user operates the GUI of the image presentation application using the keyboard 311 and/or the mouse 312, a command according to the operation is input to the image processing apparatus 102 through the operation I/F 310.

Responsive to the input of the command, the control unit 301 executing the image presentation application sets the rotation mode in the image presentation mode setting and executes processing for drawing the application screen according to the setting. The setting information of the present image presentation mode of the image presentation application is stored in the main memory 302 or the sub-memory 303, and the control unit 301 can make a determination as to the setting of the image presentation mode on the basis of the information stored in the memory.

In step S1003, the control unit 301 accepts a user's command for selecting an individual specimen to acquire information about the individual specimen selected by the user. Specifically, the user performs an operation of selecting an individual specimen that he/she wishes to observe using the keyboard 311 and/or the mouse 312 in the window in which the second image is displayed in the application screen. Responsive to the operation, a command for selecting one of the individual specimens is input to the image processing apparatus 102 through the operation I/F 310. FIG. 9B shows a case in which the individual specimen 602 that the user wishes to observe has been selected by the user using the second image 904. The process of selecting an individual specimen will be described later (see FIG. 16).

In step S1004, the control unit 301 acquires information about the position of the geometric centroid of the individual specimen selected in step S1003. The position of the geometric centroid of each of the individual specimens has been computed beforehand in the preliminary measurement, and information about the position of the geometric centroid is stored and held in the imaging apparatus 101, the storage device 308, or an apparatus in the network. The control unit 301 of the image processing apparatus 102 retrieves the information about the position of the geometric centroid from the imaging apparatus 101, the storage device 308, or the apparatus in the network.

In step S1005, the control unit 301 acquires information about the largest diameter axis of the individual specimen selected in step S1003. The largest diameter axis of each of the individual specimens has been computed beforehand in preliminary measurement, and this information is stored and held in the imaging apparatus 101, the storage device 308, or an apparatus in the network. The control unit 301 of the image processing apparatus 102 retrieves the information about the largest diameter axis of the individual specimen from the imaging apparatus 101, the storage device 308, or the apparatus in the network. As described with reference to FIGS. 9A, 9B, and 9C, the information about the shape of the individual specimen acquired in step S1005 is not limited to the information about the largest diameter axis, but it may be information about the shortest diameter axis or information about both of the largest diameter axis and the shortest diameter axis.

In step S1006, the control unit 301 computes a rotation angle of the individual specimen from the information about the position of the geometric centroid acquired in step S1004 and the information about the longest diameter axis acquired in step S1005. The rotation angle of the individual specimen is computed as such an angle that makes the longest diameter axis horizontal in the window as illustrated in FIG. 9B.

In step S1007, the control unit 301 performs drawing processing for drawing the specimen designation frame in the second image and rotation processing for rotating the individual specimen in the third image and then performs processing for presenting an image reflecting the result of above-mentioned drawing processing and rotation processing. The control unit 301 also performs processing for presenting as the first image a magnified image of the region designated by the magnified region designation frame in the third image. Specifically, the control unit 301 retrieves image data of the region designated by the magnified region designation frame in the third image and applies rotation processing on the retrieved image data in accordance with the rotation angle computed in step S1006 to generate the first image. FIG. 9B shows the second image after the rotation processing and the third image with the rotated specimen designation frame. FIG. 9C shows the first image, which is a magnified image of the region designated by the magnified region designation frame in the third image after the rotation processing.

The first image is a part of the fourth image layer in the multi-layer image shown in FIG. 5, which has the highest resolution. Therefore, the image rotation processing in generating the first image in step S1007 is rotation processing applied to a high-resolution image, which requires high-load processing.

Therefore, the processing in steps 1004 through S1007 is not performed on the image of the individual specimen selected in step S1003 after it is selected, but the processing in steps S1004 through S1007 is performed in advance for each of the individual specimens. It is preferred that the rotated images be held in the storage device 308. The timing of performing the processing in steps S1004 through S1007 for each of the individual specimens may be, for example, immediately after imaging. When this is the case, the processing in steps S1004 through S1007 may be performed either in the imaging apparatus 101 or in the image processing apparatus 102.

### (Image Rotation Based on Specimen Condition)

FIGS. 11A, 11B, and 11C are schematic diagrams illustrating image rotation and image presentation based on specimen information (specimen characteristics). The term “specimen characteristics” used in the context of this embodiment refers to a characteristic feature of the specimen as a specific lesion. For example, characteristic features of an area of a specimen suspected to be cancerous include nuclear enlargement and disordered cell arrangement. Image processing based on specimen characteristics refers image processing such as rotation performed based on information (such as position and shape) concerning a portion of the specimen that shows such characteristic features. FIG. 11A shows an exemplary image presentation with the rotation mode OFF, and FIG. 11B shows an exemplary image presentation with the rotation mode ON.

FIG. 11A shows an exemplary image presentation in a case where the rotation mode is OFF. FIG. 11A shows a window in which the second image 702 (with the rotation mode OFF) is displayed, a window in which the third image 703 (with the rotation mode OFF), and an individual specimen 602.

On the other hand, in the image presentation with the rotation mode ON, an image in which the individual specimen 602 is rotated is displayed as the third image 703. The rotation of the individual specimen 602 is performed on the condition of the individual specimen 602. In FIG. 11A, the figure of the individual specimen 602 on the right of the second image 702 and the third image 703 illustrates exemplary information representing the condition of the individual specimen 602. In the illustrated case, the information representing the condition of the individual specimen 602 is the position of a suspected cancerous area 1101 of the individual specimen 602. The suspected cancerous area is an area of the specimen which is suspected to be cancerous.

FIG. 11B shows an exemplary image presentation in a case where the rotation mode is ON. FIG. 11B shows a window in which the second image 1102 (with the rotation mode ON) is displayed, a window in which the third image 1103 (with the rotation mode ON), and an individual specimen 602. What is different in FIG. 11B from FIG. 11A is that the individual specimen 602 displayed in the third image 1103 is rotated in such a way that a suspected cancerous area 1101 is located at an upper left position in the window. The third image 1103 (with the rotation mode ON) is an image of the individual specimen 602 rotated in the above-described manner. In the second image 1102 (with the rotation mode ON), the specimen designation frame 704 is rotated in accordance with the rotation of the individual specimen 602 in the third image 1103. The magnified region designation frame 705 appearing in the third image 1103 (with the rotation mode ON) has a frame shape the same as the magnified region designation frame 705 in FIG. 11A. However, since the individual specimen 602 in the third image 1103 is rotated, the magnified region designated by the frame in FIG. 11A and the magnified region designated by the frame in FIG. 11B are different from each other.

FIGS. 11A and 11B show an illustrative case in which image rotation is performed focusing on a suspected cancerous area of the individual specimen 602. However, image rotation may be performed focusing on an area suspected to be affected due to any disease other than cancer.

FIG. 11C shows an exemplary screen of the image presentation application in a case where the rotation mode is ON. The first image 1104 (with the rotation mode ON), the second image 1102 (with the rotation mode ON), and the third image 1103 (with the rotation mode ON) reflect the rotation effected in the case shown in FIG. 11B, where the rotation mode is ON. Thus, what is displayed in the screen shown in FIG. 11C is different from that in FIG. 7A. What differs in FIG. 11C from FIG. 7A is that the individual specimen 602 in the third image 1103 (with the rotation mode ON) is rotated and that the specimen designation frame 704 in the second image 1102 (with the rotation mode ON) is rotated. The magnified region (the region of the individual specimen displayed in the magnified manner) displayed in the first image 701 in FIG. 7A and the magnified region displayed in the first image 1104 (with the rotation mode ON) in FIG. 11C are different from each other, though the schematic illustrations in FIGS. 7A and 11C do not show the difference specifically.

The rotation of the first image, the third image, and the frame in the second image specifying a region in the third image effected based on the condition of the specimen as shown in FIG. 11B can lead to a reduction in the burden on the user in observing (or screening) the specimen. Specific advantageous effects will be described later (see FIGS. 17A to 17E).

### (Process of Image Rotation Based on Specimen Condition)

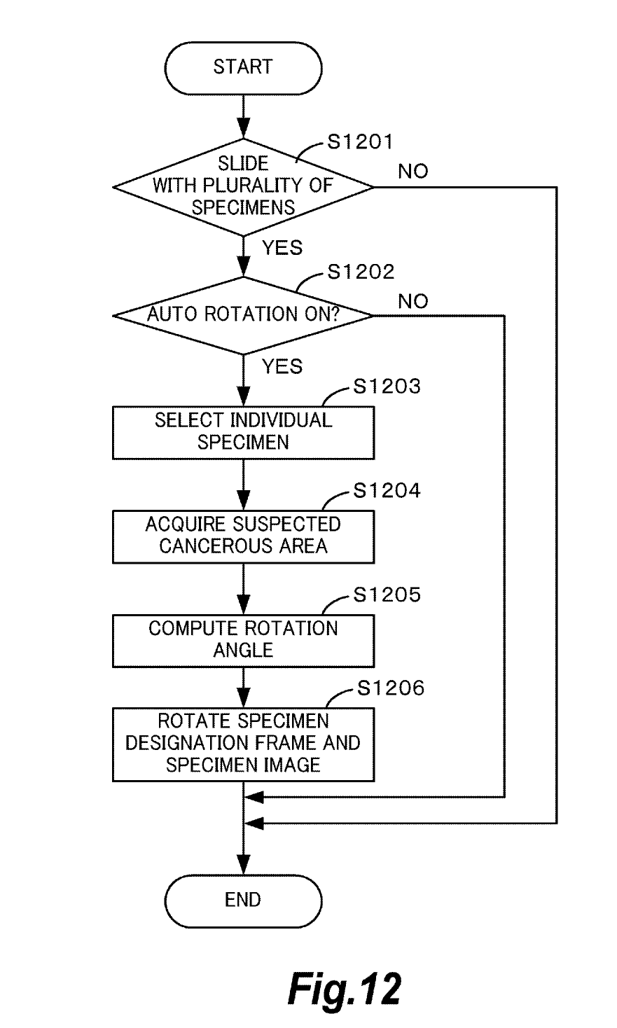

FIG. 12 is a flow chart of a process of image rotation based on specimen information (specimen characteristics). In the following, an illustrative case in which an image of an individual specimen is rotated based on the position of a suspected cancerous area of the specimen will be described. However, this is an example of image processing based on specimen characteristics, and it should be noted that the present invention is not intended to be limited to this process. The process shown in the flow chart of FIG. 12 is executed by the control unit 301 of the image processing apparatus 102, which executes the image presentation application.

In step S1201, the control unit 301 makes a determination as to whether or not there are a plurality of specimens on the slide 206. This step is executed in the preliminary measurement. For instance, information about the number of specimens is written or electronically recorded on the label 601 beforehand at the time of preparation of the slide 206, and the information on the label 601 is read in the preliminary measurement to acquire the information about the number of specimens.

The information about the number of specimen is stored and held in the imaging apparatus 101, the storage device 308, or an apparatus in the network. The control unit 301 of the image processing apparatus 102 retrieves the information about the number of specimens from the imaging apparatus 101, the storage device 308, or the apparatus in the network and makes a determination as to whether or not there are a plurality of specimens on the slide 206 on the basis of this information.

Alternatively, an image of the slide 206 captured by imaging in the preliminary measurement may be stored and held in the imaging apparatus 101, the storage device 308, or an apparatus in the network. In this case, the control unit 301 of the image processing apparatus 102 may retrieve the image of the slide 206 from the imaging apparatus 101, the storage device 308, or the apparatus in the network and determine the number of specimen by image processing.

In step S1202, the control unit 301 makes a determination as to whether or not auto-rotation is set to ON in the image presentation mode setting of the image presentation application. Auto-rotation can be set to ON by the user with the display menu described above with reference to FIG. 8. As the user operates the GUI of the image presentation application using the keyboard 311 and/or the mouse 312, a command according to the operation is input to the image processing apparatus 102 through the operation I/F 310.

Responsive to the input of the command, the control unit 301 executing the image presentation application sets the rotation mode in the image presentation mode setting and executes processing for drawing the application screen according to the setting. The setting information of the present image presentation mode of the image presentation application is stored in the main memory 302 or the sub-memory 303, and the control unit 301 can make a determination as to the setting of the image presentation mode on the basis of the information stored in the memory.

In step S1203, the control unit 301 accepts a user's command for selecting an individual specimen to acquire information about the individual specimen selected by the user. Specifically, the user performs an operation of selecting an individual specimen that he/she wishes to observe using the keyboard 311 and/or the mouse 312 in the window in which the second image is displayed in the application screen. Responsive to the operation, a command for selecting one of the individual specimens is input to the image processing apparatus 102 through the operation I/F 310. FIG. 11B shows a case in which the individual specimen 602 that the user wishes to observe has been selected by the user using the second image 1102. The process of selecting an individual specimen will be described later (see FIG. 16).

In step S1204, the control unit 301 acquires information about a suspected cancerous area of the individual specimen selected in step S1203. The suspected cancerous area of the individual specimen has a mark attached in advance in screening conducted by a cytotechnologist. One method of attaching a mark in an analog fashion is to draw a mark directly on the slide 206 using a pen to indicate a suspected cancerous area. Another method is to display an image captured by imaging the slide 206 on a viewer and to add an annotation digitally on the viewer. Screening is a preliminary observation, which may be performed on an image having a low magnification. The marking information of the suspected cancerous area of the individual specimen is stored and held in the imaging apparatus 101, the storage device 308, or an apparatus in the network. The control unit 301 of the image processing apparatus 102 retrieves the marking information of the suspected cancerous region of the individual specimen from the imaging apparatus 101, the storage device 308, or the apparatus in the network.

In step S1205, the control unit 301 computes a rotation angle of the individual specimen on the basis of the information about the suspected cancerous area acquired in step S1204. The rotation angle of the individual specimen is computed as such an angle that causes the suspected cancerous area to be located at an upper left position in the window as shown in FIG. 11B. Here, an illustrative case where the image of the individual specimen is rotated in such a way that the suspected cancerous area is located at an upper left position in the window is described by way of example. What is essential in the processing of this embodiment is to rotate the image of the individual specimen in such a way that the suspected cancerous area is located at an observation start position or an observation finish position in the window according to user preferences.

In step S1206, the control unit 301 performs drawing processing for drawing the specimen designation frame in the second image and rotation processing for rotating the individual specimen in the third image and then performs processing for presenting an image reflecting the result of above-mentioned drawing processing and rotation processing. The control unit 301 also performs processing for presenting as the first image a magnified image of the region designated by the magnified region designation frame in the third image. Specifically, the control unit 301 retrieves image data of the region designated by the magnified region designation frame in the third image and applies rotation processing on the retrieved image data in accordance with the rotation angle computed in step S1205 to generate the first image. FIG. 11B shows the second image after the rotation processing and the third image with the rotated specimen designation frame. FIG. 11C shows the first image, which is a magnified image of the region designated by the magnified region designation frame in the third image after the rotation processing.

The image rotation based on the specimen shape described with reference to FIGS. 9A to 9C and 10 can be performed automatically by image processing or the like. In contrast, in the case where the image rotation based on the specimen characteristics described here is performed, it is necessary that some findings (based on which image rotation processing can be performed) about the condition of the individual specimen have been made after imaging of the specimen. To make such findings about the specimen characteristics (or information such as information about the position of a suspected lesion or an area suspected to be affected), examination by a cytotechnologist or pathologist is generally needed.

In this embodiment, the slide 206 is imaged by the imaging apparatus 101, and images captured by imaging are stored in the storage device 308 of the image processing apparatus 102. A cytotechnologist or pathologist conducts screening as to the condition of individual specimens using the stored images. It is preferred that the result of screening be stored in some form such as a digital annotation or analog marking so that it can be utilized in the image rotation processing.

In cytological diagnosis, screening is typically conducted by a cytotechnologist, and thereafter diagnosis by a pathologist is conducted. In the screening by the cytotechnologist, preliminary examination about the characteristics of an individual specimen is typically conducted. The result of this preliminary examination may include specimen characteristics information for use in the image rotation processing based on the specimen characteristics according to this embodiment. This enables the pathologist to conduct diagnosis with an image rotated according to the specimen characteristics by the image presentation application. Therefore, an advantageous effect of the present invention, or a reduction of burden on the pathologist in the operation in observing the specimen, can be expected to be achieved.

The image rotation based on the specimen characteristics may also be performed automatically. For example, the condition of the individual specimen may be determined by image processing or other processing (namely, suspected lesion may be extracted mechanically) on the basis of clinical findings of a portion from which the specimen of the slide 206 was taken. For example, because there is nuclear enlargement and disordered cell arrangement in an area suspected to be cancerous, such an area tends to appear darker in an HE (hematoxylin and eosin) stained image than the normal area. It is possible based on this tendency to find (or distinguish) a suspected lesion (i.e. suspected cancerous area) in an individual specimen by extracting an area in the HE stained image in which the brightness is lower than a reference value by image processing. Thus, rotation of the image of the individual specimen may be performed automatically based on information about the specimen characteristics (e.g. the position of a suspected cancerous area) obtained by image processing or the like.

In this embodiment, there has been described an illustrative case in which the position of a suspected cancerous area is used as information about the specimen characteristics. The information about the specimen characteristics is not limited to this, but it may be information about a suspected lesion such as inflammation or tumor.

### (Image Rotation Based on Smallest Circumscribed Rectangle)

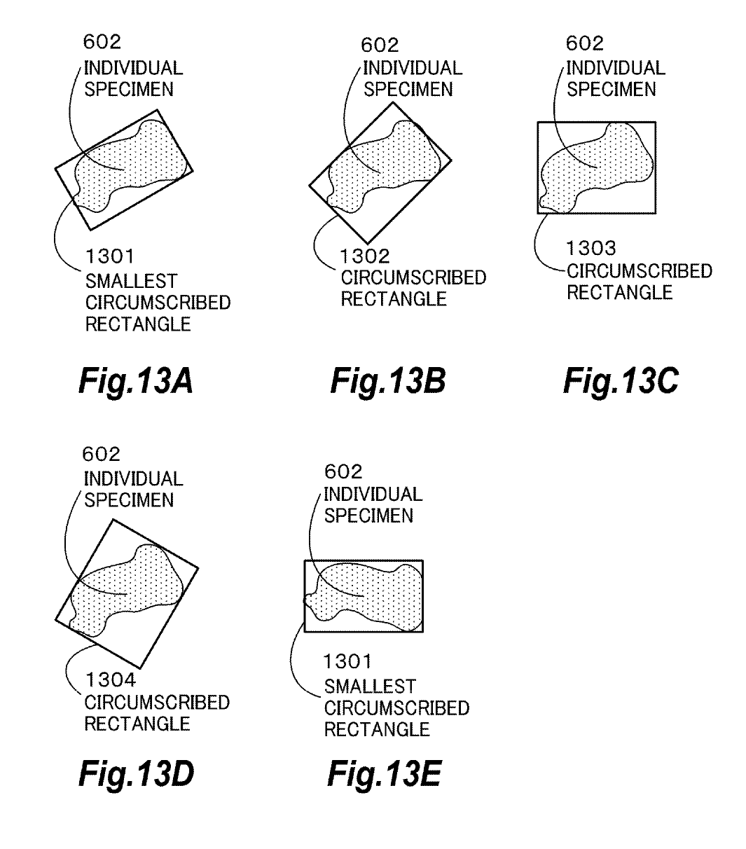

FIGS. 13A to 13E are schematic diagrams illustrating image rotation and image presentation based on a smallest circumscribed rectangle.

FIGS. 13A to 13D show four patterns of the circumscribed rectangle of the individual specimen 602. The area of the circumscribed rectangle changes with the rotational angle of the circumscribed rectangle. The rotational angle of the rectangle mentioned herein is defined as the angle formed by one of the sides of the rectangle and a predetermined reference line (e.g. the X axis in a two-dimensional X-Y coordinate system).

The circumscribed rectangle shown in FIG. 13A has the smallest area among the four circumscribed rectangle patterns and will be referred to as the smallest circumscribed rectangle 1301. The circumscribed rectangles 1302, 1303, and 1304 shown in FIGS. 13B, 13C, and 13D have areas larger than the smallest circumscribed rectangle 1301 shown in FIG. 13A.

In the case described here, image rotation of the individual specimen 602 is performed based on the rotational angle of the smallest circumscribed rectangle 1301. In other words, the image of the individual specimen 602 is rotated based on the rotational angle of the circumscribed rectangle of the individual specimen 602 at which the area of the circumscribed rectangle becomes smallest. An existing algorithm can be used as an algorithm for computing the smallest circumscribed rectangle based on the shape of the individual specimen 602. The shape of the individual specimen 602 can be acquired automatically by, for example, image processing based on contrast.

FIG. 13E shows a case in which the individual specimen 602 is rotated based on the rotational angle of the circumscribed rectangle of the individual specimen 602 at which the area of the circumscribed rectangle becomes smallest (i.e. the rotational angle of the smallest circumscribed rectangle 1301). The image of the individual specimen 602 shown in FIG. 13E is displayed in the third image. Rotation of the image of the individual specimen based on the rotational angle of the circumscribed rectangle is preformed, for example, in such a way that the longer side or the shorter side thereof is oriented parallel or perpendicular to the window in which the individual specimen is displayed.

### (Process of Image Rotation Based on Smallest Circumscribed Rectangle)

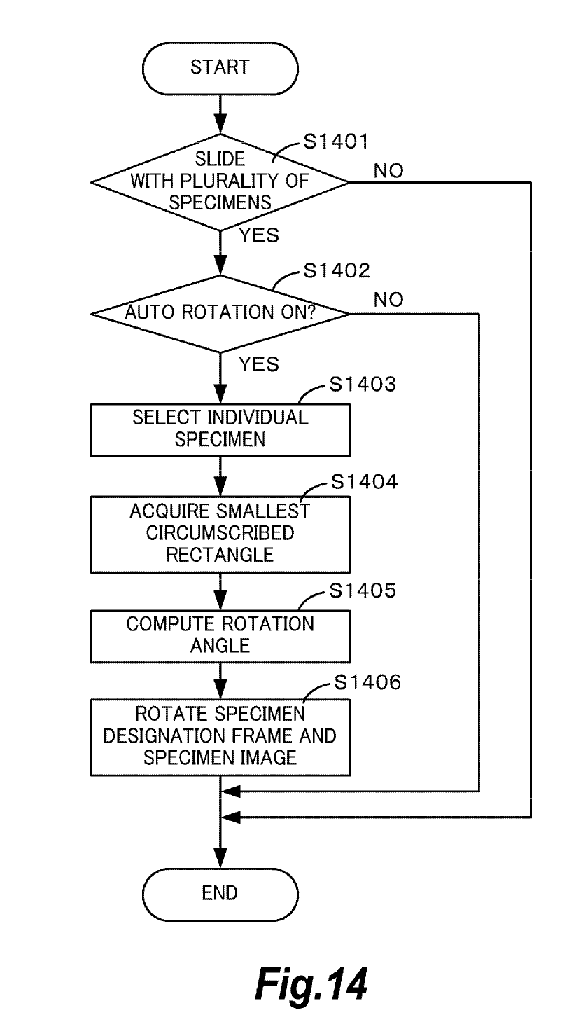

FIG. 14 is a flow chart of a process of image rotation based on the smallest circumscribed rectangle. The process shown in the flow chart of FIG. 14 is executed by the control unit 301 of the image processing apparatus 102, which executes the image presentation application.

In step S1401, the control unit 301 makes a determination as to whether or not there are a plurality of specimens on the slide 206. This step is executed in the preliminary measurement. For instance, information about the number of specimens is written or electronically recorded on the label 601 beforehand at the time of preparation of the slide 206, and the information on the label 601 is read in the preliminary measurement to acquire the information about the number of specimens.

The information about the number of specimen is stored and held in the imaging apparatus 101, the storage device 308, or an apparatus in the network. The control unit 301 of the image processing apparatus 102 acquires the information about the number of specimens from the imaging apparatus 101, the storage device 308, or the apparatus in the network and makes a determination as to whether or not there are a plurality of specimens on the slide 206 on the basis of this information.

Alternatively, an image of the slide 206 captured by imaging in the preliminary measurement may be stored and held in the imaging apparatus 101, the storage device 308, or an apparatus in the network. In this case, the control unit 301 of the image processing apparatus 102 may retrieve the image of the slide 206 from the imaging apparatus 101, the storage device 308, or the apparatus in the network and determine the number of specimen by image processing.

In step S1402, the control unit 301 makes a determination as to whether or not auto-rotation is set to ON in the image presentation mode setting of the image presentation application. Auto-rotation can be set to ON by the user with the display menu described before with reference to FIG. 8. As the user operates the GUI of the image presentation application using the keyboard 311 and/or the mouse 312, a command according to the operation is input to the image processing apparatus 102 through the operation I/F 310. Responsive to the input of the command, the control unit 301 executing the image presentation application sets the rotation mode in the image presentation mode setting and executes processing for drawing the application screen according to the setting. The setting information of the present image presentation mode of the image presentation application is stored in the main memory 302 or the sub-memory 303, and the control unit 301 can make a determination as to the setting of the image presentation mode on the basis of the information stored in the memory.

In step S1403, the control unit 301 accepts a user's command for selecting an individual specimen to acquire information about the individual specimen selected by the user. Specifically, the user performs an operation of selecting an individual specimen that he/she wishes to observe using the keyboard 311 and/or the mouse 312 in the window in which the second image is displayed in the application screen. Responsive to the operation, a command for selecting one of the individual specimens is input to the image processing apparatus 102 through the operation I/F 310. The process of selecting an individual specimen will be described later (see FIG. 16).

The processing in steps S1401 to S1403 is the same as that in steps S1001 to S1003 in FIG. 10.

In step S1404, the control unit 301 retrieves information about the smallest circumscribed rectangle of the individual specimen selected in step S1403. The smallest circumscribed rectangle of each of the individual specimens has been calculated in advance in preliminary measurement, and information about the smallest circumscribed rectangle is stored and held in the imaging apparatus 101, the storage device 308, or an apparatus in the network. The control unit 301 of the image processing apparatus 102 retrieves the information about the smallest circumscribed rectangle from the imaging apparatus 101, the storage device 308, or the apparatus in the network.

In step S1405, the control unit 301 computes the rotation angle of the individual specimen on the basis of the smallest circumscribed rectangle acquired in step S1404. The rotation angle of the individual specimen is computed as such an angle that makes the longer side or the shorter side parallel in the window.

In step S1406, the control unit 301 performs drawing processing for drawing the specimen designation frame in the second image and rotation processing for rotating the individual specimen in the third image and then performs processing for presenting an image reflecting the result of above-mentioned drawing processing and rotation processing. The control unit 301 also performs processing for presenting as the first image a magnified image of the region designated by the magnified region designation frame in the third image. Specifically, the control unit 301 retrieves image data of the region designated by the magnified region designation frame in the third image and applies rotation processing on the retrieved image data in accordance with the rotation angle computed in step S1405 to generate the first image.

The first image is a part of the fourth image layer in the multi-layer image shown in FIG. 5, which has the highest resolution. Therefore, the image rotation processing in generating the first image in step S1406 is rotation processing applied to a high-resolution image, which requires high-load processing. Therefore, the processing in steps 1404 through S1406 is not performed on the image of the individual specimen selected in step S1403 after it is selected, but the processing in steps S1404 through S1406 is performed in advance for each of the individual specimens. It is preferred that the rotated images be held in the storage device 308. The timing of performing the processing in steps S1404 through S1406 for each of the individual specimens may be, for example, immediately after imaging. When this is the case, the processing in steps S1404 through S1406 may be performed either in the imaging apparatus 101 or in the image processing apparatus 102.

### (Manual Rotation of Image)

While the embodiment of the present invention configured to rotate the image automatically based on the shape or condition of the specimen has been described in the foregoing with reference to FIGS. 9A to 14, the embodiment of the present invention may be configured to allow manual rotation of the image. Preferred mode of observation of individual specimens can vary among users. Manual image rotation allows the image be presented in an observation mode adapted to user preferences. The image presentation setting in the image presentation application described with reference to FIG. 8 allows the user to set “Auto Rotation ON” or “Manual Rotation ON”.

When “Manual Rotation ON” is set, the user is allowed to place the mouse pointer on the image of an individual specimen he/she wishes to rotate and dragging the mouse to thereby input a command for rotating the individual specimen designation frame to the image processing apparatus 102.

(Image Presentation with Image Orientation Indicator)

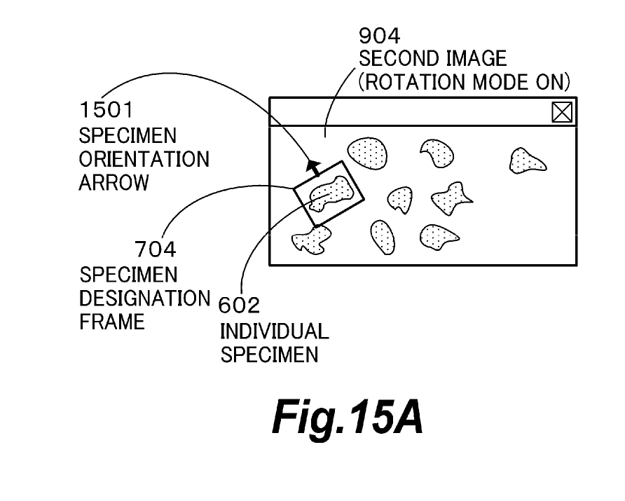

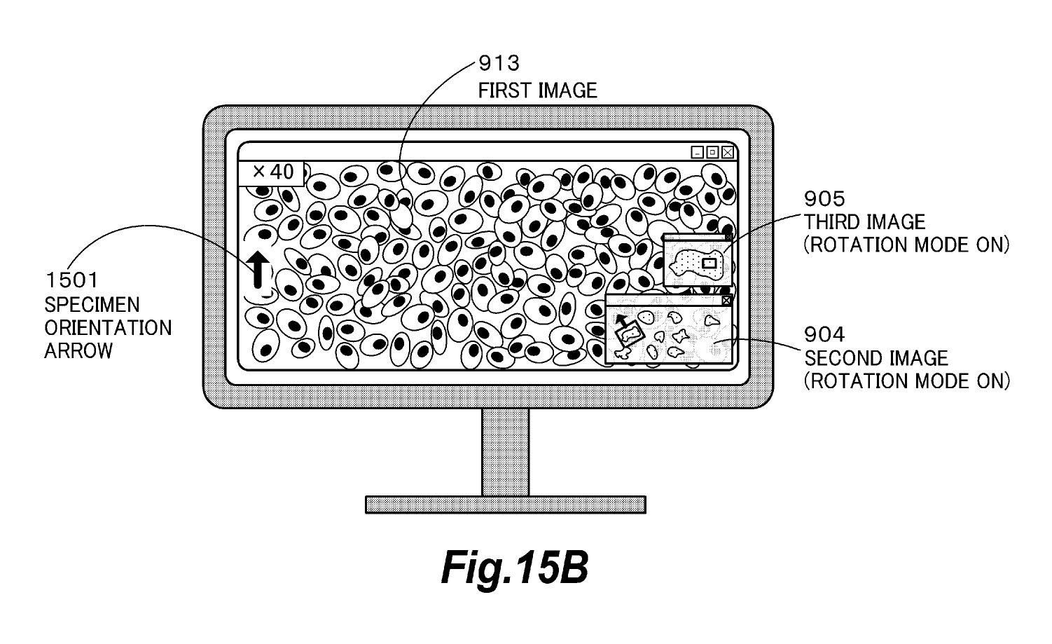

FIG. 15 shows another exemplary screen of the image presentation application according to the present invention. What is different in the image presentation shown in FIG. 15 from the image presentations shown in FIGS. 9C and 11C is mainly that orientation indicators (arrow) serving as orientation indication marks indicating the orientation or direction of images (in other words, the rotation angles of the first image and the third image) are additionally displayed.

FIG. 15A shows the second image 904, in which the specimen designation frame 704 is rotated in accordance with the rotation of the individual specimen 602 in the first image 913 and the third image 905. In order to enable the user to clearly see the inclination of the first image 913 and the third image 905 relative to the second image 904, a specimen orientation arrow 1501 serving as an orientation indicator is added to the specimen designation frame 704 in the second image 904.

FIG. 15B shows an exemplary screen of the image presentation application according to the present invention. In this illustrative screen, specimen orientation arrows 1501 serving as orientation indicators are displayed in the first image 913 and the second image 904. This enables the user to easily know the angle (inclination) between the first image 913 and the second image 904. The angle of the specimen orientation arrow 1501 relative to the slide in the second image 904 is equal to the angle of the specimen orientation arrow 1501 relative to the slide in the first image 913. In other words, the direction in the second image 904 which is parallel to the horizontal direction of the window in which the second image 904 is displayed and the direction in the first image 913 which is parallel to the horizontal direction of the window in which the first image 913 is displayed are inclined relative to each other in the actual specimen (or slide) by an angle equal to the angle formed by the specimen orientation arrows 1501 in the respective images.

### (Method of Designating Individual Specimen)

FIGS. 16A and 16B are schematic diagrams illustrating the process of designating a specific individual specimen in the second image.

FIG. 16A shows the window in which the second image 1601 is displayed. The user designates an individual specimen using a designation pointer (mouse pointer) in this window. The designation pointer is illustrated as an individual specimen selection arrow 1602. The second image 1601 is divided into a plurality of individual specimen selection areas 1604 by individual specimen selection boundaries 1603 drawn by broken lines. The individual specimen selection boundaries are set in such a way that each of the individual specimen selection areas includes one individual specimen.

The broken lines indicating the individual specimen selection boundaries 1603 may either be actually displayed in the second image 1601 as shown in FIG. 16A or not displayed. FIG. 16B shows an individual specimen selection area 1604 alone in which individual specimen 602 exists. The user can input a command for selecting this individual specimen 602 by performing the operation of shifting (or placing) the individual specimen selection arrow 1602 onto the individual specimen selection area 1604 in which the individual specimen 602 exists and performing an additional operation such as clicking if needed.

In cases where the size of the second image displayed is relatively small in relation to the entire application screen displayed in the screen of the display apparatus 103 as shown in FIGS. 9C, 11C, and 15B, it is difficult to operate the mouse to shift the mouse cursor precisely onto the individual specimen in the second image. The above-described process facilitates the operation of inputting a command for selecting an individual specimen, because the above-described process enables the user to designate the individual specimen 602 without requiring him/her to shift the individual specimen selection arrow 1602 precisely onto the individual specimen 602.

### Advantageous Effects

FIGS. 17A to 17E are schematic diagrams illustrating advantageous effects of the present invention.

FIG. 17A shows an individual specimen 1701 to which image rotation has not been applied. The individual specimen 1701 corresponds to the individual specimen 602 shown in FIGS. 9A, 11A, and 13A to 13E. An observation area 1702 indicated by a rectangular frame is an area which can be displayed in the window in which the first image (magnified image for detailed observation) is displayed in the image presentation application at a time. If the size of the entire image of the individual specimen 1701 in the high-resolution image layer for detailed observation is larger than the size of the image that can be displayed in the window at a time, it is necessary for the user to shift the observation area 1702 during the observation to observe the entirety of the individual specimen 1701.

Users (i.e. cytotechnologists and pathologists etc.) have their own preferences in the way of shifting observation area 1702. FIG. 17A shows an exemplary way of shifting the observation area 1702 in which the user performs observation (or screening) while shifting the observation area 1702 from the lower left part to the upper right part of the individual specimen 1701.

Examples of operations for shifting the observation area 1702 in the image presentation application include dragging with the mouse and operations of arrow keys of the keyboard. Although dragging with the mouse can shift the observation area 1702 in desired directions (e.g. shifts indicated by oblique arrows in FIG. 17A), it is necessary for the user to shift the observation area 1702 carefully in order to prevent oversight, leading to heavy mental burden for the user. On the other hand, in the case of shifts in vertical and horizontal directions with keyboard operations, although the possibility of oversight can be reduced, the efficiency in observation will be deteriorated in cases where a long and narrow individual specimen is displayed in an oblique orientation as is the case with the individual specimen 1701 shown in FIG. 17A, because the specimen occupies only a small part of the window in many observation areas in such cases.

FIG. 17B shows the individual specimen 1701 after image rotation. In FIG. 17B, the individual specimen 1701 is rotated in such a way that the longest diameter axis of the individual specimen 1701 is oriented horizontal in the window as described above with reference to FIGS. 9A to 9C. With this image rotation, the number of times of oblique shift operation can be reduced to two in the case shown in FIG. 17B, while the number of times of oblique shift operation is six in the case shown in FIG. 17A. Therefore, the rotation of the image of the individual specimen can reduce the burden on the user in performing oblique shift operation.

The image presentation application may be configured to allow the user to set and store a preferred scrolling direction in advance and to select it upon observation.

FIG. 17C shows an illustrative case in which the image is rotated in accordance with the scrolling direction set by the user. If the user sets the scrolling direction in scrolling the image in a constant direction during observation to vertical, the image is rotated in the manner shown in FIG. 17C. The thus-rotated image allows successive observations along the vertical direction, leading to reduced burden in specimen observation (or screening) for users who prefer vertical scrolling. Moreover, the number of times of oblique shift operation is reduced to three, leading to a reduction in the burden on the user in performing oblique shift operation as with the case shown in FIG. 17B.

FIG. 17D shows another illustrative case in which the image is rotated in accordance with the scrolling direction set by the user. If the user sets the scrolling direction in scrolling the image in a constant direction during observation to horizontal, the image is rotated in the manner shown in FIG. 17D. The thus-rotated image allows successive observations along the horizontal direction, leading to reduced burden in specimen observation (or screening) for users who prefer horizontal scrolling. Moreover, the number of times of oblique shift operation is reduced to three, leading to a reduction in the burden on the user in performing oblique shift operation as with the case shown in FIG. 17B.

In specimen observation (or screening), users commonly examine a normal area and an abnormal area (lesion) in comparison and contrast with each other. With which of a normal area and an abnormal area in the individual specimen users begin the observation depends on users. Beginning the observation with a normal area may facilitate recognition of an abnormal area (lesion) in some cases, and beginning the observation (or screening) with an abnormal area may facilitate recognition of a normal area in other cases. Therefore, rotating the image based on the condition of the specimen as described with reference to FIGS. 11A to 11C and 12 can also reduce the burden on the user in specimen observation (screening).

For example, if the user likes to begin the observation with an abnormal area and from the upper left part of the specimen, it is preferred to rotate the image of the individual specimen 602 in such a way that a suspected cancerous area 1101 is located at an upper left position as shown in FIG. 11B. It is preferred for the image presentation application to allow the user to set the order of observation (beginning with a normal area or an abnormal area), the position from which observation is started, and the direction of observation (scrolling direction) according to his/her preferences so that the way of image rotation can be controlled according to the user preferences. It is preferred that such settings be set and stored in advance or can be set each time observation is performed.

FIG. 17E is a diagram illustrating an advantageous effect of image rotation using the smallest circumscribed rectangle. In the case of an individual specimen 1704 having a warped shape as shown in FIG. 17E, the centroid 1705 of the individual specimen is sometimes located outside it, and the largest diameter axis and the shortest diameter axis cannot be defined. In such cases, the image rotation using the smallest circumscribed rectangle described with reference to FIGS. 13A to 13E and 14 or manual image rotation is performed. Practically, it is preferred that the user be allowed to manually rotate the image when automatic image rotation is not possible or when automatic image rotation is not preferable for the user.

### Application of First Embodiment

In the following, a case where image rotation is applied to a depth image will be described as an application of the first embodiment (in which the present invention is applied to a two-dimensional image).

### (Structure of Multi-Layer Image Data Additionally Having Depth Structure)

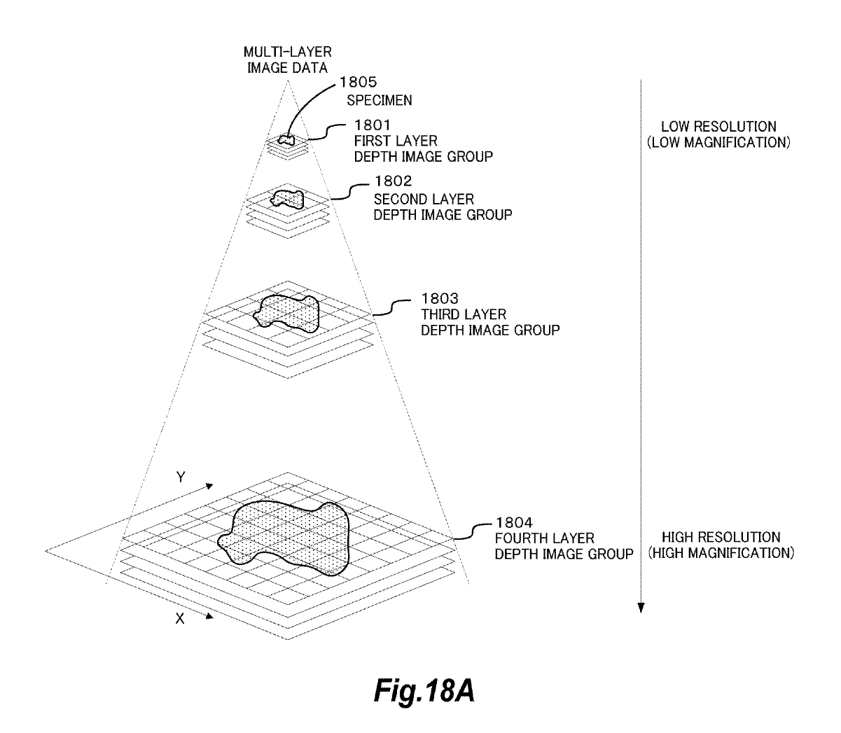

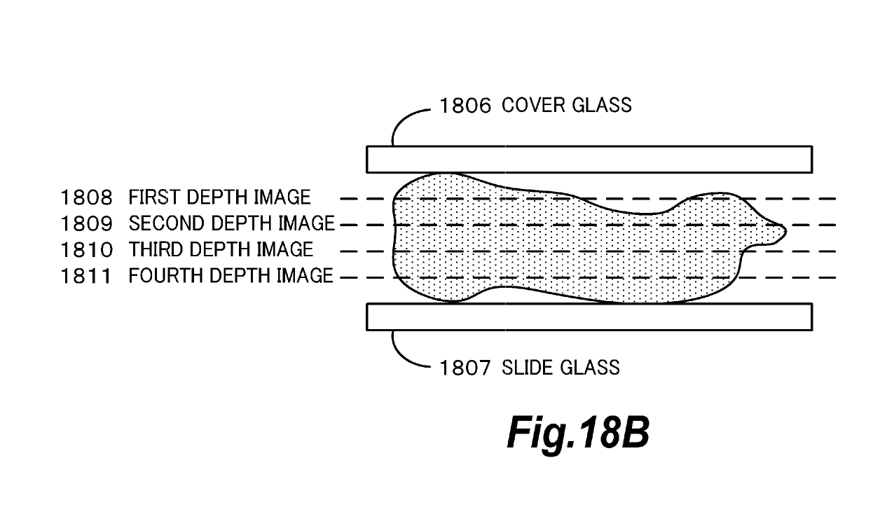

FIGS. 18A and 18B are schematic diagram illustrating multi-layer image data additionally having a depth structure. In the illustrative case described herein, it is assumed that the multi-layer image data is composed of four layer depth image groups having different resolutions (or numbers of pixels), including a first layer depth image group 1801, a second layer depth image group 1802, a third layer depth image group 1803, and a fourth layer depth image group 1804. In this multi-layer image data, unlike with that shown in FIG. 5, each layer has a depth structure to include four depth images. The number of layers and the number of depths are not limited to those mentioned above.

A specimen 1805 is a slice of tissue or a smear of cells to be observed. In FIG. 18A, the same specimen 1805 is illustrated in different sizes in the respective layers of images to facilitate the understanding of the layered structure. The first layer depth image group includes images having the lowest resolution among the four layers of image groups, which are used as a thumbnail image or the like. The second layer image group 1802 and the third layer image group 1803 include images having medium resolutions, which are used for large-area observation of the virtual slide image. The fourth layer image group 1804 includes images having the highest resolution, which are used when the virtual slide image is observed in detail.

Each image in each layer is constituted by a collection of a certain number of blocks of compressed images. For example, in the case of JPEG compression, each compressed image block is a single JPEG image. In the illustrated case, each image in the first layer depth image group 1801 is composed of one compressed image block, each image in the second layer depth image group 1802 is composed of four compressed image blocks, each image in the third layer depth image group 1803 is composed of 16 (sixteen) compressed image blocks, and each image in the fourth layer depth image group 1804 is composed of 64 (sixty-four) compressed image blocks.

Differences in the resolution are analogous to differences in the optical magnification in the microscope observation. Specifically, observation of an image in the first layer depth image group 1801 displayed on the display apparatus corresponds to microscope observation at a low magnification, and observation of an image in the fourth layer depth image group 1804 displayed on the display apparatus corresponds to microscope observation at a high magnification. For example, if the user wishes to observe a specimen in detail, he/she may cause the display apparatus to display images in the fourth layer depth image group 1804 for observation.

FIG. 18B is a schematic diagram illustrating the depth structure. FIG. 18B is a cross sectional view taken on a cross section perpendicular to the surface of a slide 206. The slide 206 is a piece prepared by placing a specimen (which is a slice of tissue or a smear of cells to be observed) on a slide glass 1807 and fixing it under a cover glass 1806 with mounting agent. The specimen is a transparent object having a thickness from a few micrometers to several tens of micrometers. A depth image group is composed of a plurality of images captured by imaging the specimen with the same imaging area at a plurality of depths (i.e. a plurality of positions with respect to the thickness direction or a plurality of focusing positions). The depth image group enables the user to observe the specimen at different depths (different positions with respect to the thickness direction). In the case shown in FIG. 18B, there are a first depth image 1808, a second depth image 1809, a third depth image 1810, and a fourth depth image 1811 as depth images captured by imaging at different depth. In this illustrative case, the depth image group of each layer in FIG. 18A is composed of fourth depth images shown in FIG. 18B.

### (Image Rotation of Depth Image)

An exemplary case in which image rotation is applied to a certain single depth image will be described with reference to FIGS. 9A to 9C, 18A, and 18B.

The imaging apparatus 101 images the slide 206 to capture depth images in the fourth layer. The imaging apparatus 101 or the image processing apparatus 102 performs processing to generate images in layers of lower resolutions (i.e. the depth images in the first to third layers) from the images in the layer of the highest resolution (i.e. the depth images in the fourth layer). The images in the layers of lower resolutions are stored in a storage device 308.

The second image 904 is an image in the first layer. Specifically, the image having a high overall focusing quality over the entire image among the images in the first layer depth image group is selected as the second image 904. The third image 905 is generated from a depth image in a layer having a higher resolution than the first layer, namely a depth image in one of the second, third, and fourth layers. As the third image 905, a depth image having a high focusing quality over the individual specimen 602 is selected. Therefore, it is not necessary that the depth of the second image 904 and the depth of the third image 905 be the same. For example, there may be a case where while the depth image having a high focusing quality as the second image 904 is the second depth image 1809, the depth image having a high focusing quality as the third image 905 is the third depth image 1810. In such a case, image rotation processing for the third image 905 is applied to a depth image having a depth different from the depth of the second image 904.

The focusing quality of an image can be determined based on the image contrast. The image contrast E can be calculated by the following equation:

E=Σ(L(m,n+1)−L(m,n))²+Σ(L(m+1,n)−L(m,n))²,

where L(m, n) is the brightness component of each pixel, m represents the position of the pixel with respect to the Y direction, and n represents the position of the pixel with respect to the X direction.

The first term in the right side of the equation represents the brightness difference between adjacent pixels along the X direction, and the second term represents the brightness difference between the adjacent pixels along the Y direction. The image contrast E can be calculated as the sum of squares of the brightness differences between adjacent pixels along the X direction and the Y direction.

As the first image 906, a depth image having a high focusing quality in the region designated by the magnified region designation frame 705 in the third image 905 is selected from among the depth images in the fourth layer depth image group having the highest resolution. Therefore, there may be cases where the depth of the first image 906 and the depth of the third image 905 are different from each other. For example, there may be a case where while the depth image selected as the first image 906 is the fourth depth image 1811, and the depth image selected as the third image 903 is the third depth image 1810. In such a case, a depth image having a depth different from the third image 905 is retrieved to display the first image 906 as a magnified image of the region designated by the magnified region designation frame 705 in the third image 905.

As described above, for displaying the first, second, and third images, images having high image qualities in the respective regions displayed in the first, second, and third images are selected from the images in the depth image groups. The region displayed in the first image is the region designated by the magnification region designation frame in the third image, the region displayed in the second image is the entire area of the slide 206, and the region displayed in the third image is a region containing the entirety of the individual specimen 602 selected in the second image.

In the above described illustrative embodiment, the information about the number of specimens on the slide, the information about the specimen shape, the information about the specimen characteristics, and the information about the smallest circumscribed rectangle etc. are obtained in preliminary measuring and stored and held in an apparatus such as the imaging apparatus, the image processing apparatus, or an apparatus on the network. The information about them may be added to the multi-layer image data as metadata and sent/received together with the multi-layer image data, between the imaging apparatus, the image processing apparatus, and apparatuses in the network.

### Second Embodiment

The second embodiment is an application of the present invention to presentation of a three-dimensional specimen image.

The image processing apparatus according to the present invention can be used in an image processing system including an imaging apparatus and a display apparatus. The configuration of the image processing system, the functional blocks of the imaging apparatus in the image processing system, the hardware construction of the image processing apparatus, the functional blocks of the control unit of the image processing apparatus, the structure of multi-layer image data, and the construction of the slide are the same as those described in the description of the first embodiment and will not be described further.

The first embodiment is directed to a flat specimen and suitably applied to pathological tissue diagnosis. Specimens used in tissue diagnosis are as thin as approximately four micrometers and can be regarded as a planar specimen. On the other hand, the second embodiment is directed to a three-dimensional specimen and suitably applied to pathological cytodiagnosis. Specimens used in cytodiagnosis have a thickness from a few tens of micrometers to 100 micrometers and can be regarded as three-dimensional specimens. The second embodiment is characterized in its method of image presentation for a cross section (main cross section) which the user wishes to observe and provides advantages in reducing the burden on the user in specimen observation (screening).

### (Three-Dimensional Specimen)

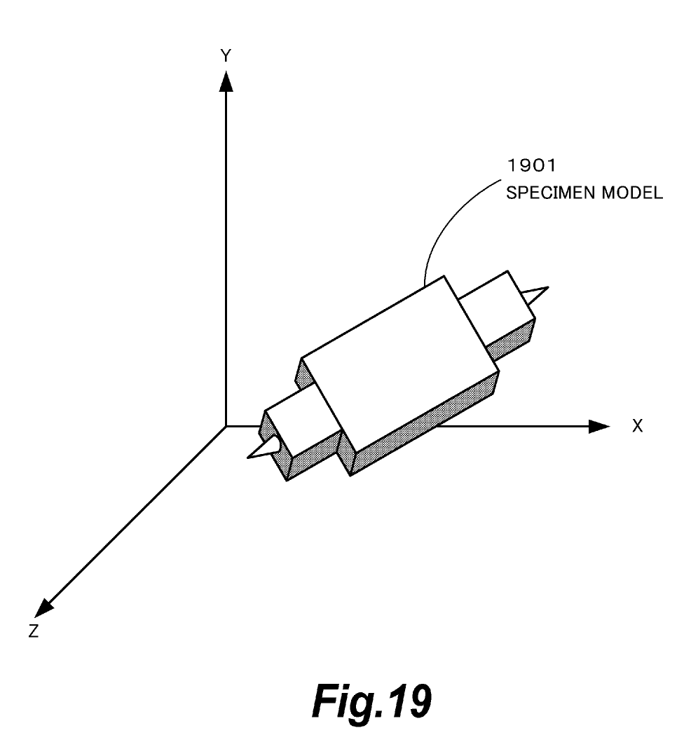

FIG. 19 is a schematic diagram illustrating a three-dimensional specimen. Here, a specimen model 1901 constructed as a combination of cuboids and cones is used as a model of a specimen for cytodiagnosis. This is a model simulating an overlapped cell aggregate. This three-dimensional specimen corresponds to the individual specimen 602 shown in FIG. 6 in the first embodiment, where the X-Y plane corresponds to the surface of the slide 206, and the Z axis corresponds to the axis perpendicular to the surface of the slide 206 (i.e. the axis in the thickness direction or depth direction).

### (Construction of Three-Dimensional Specimen)

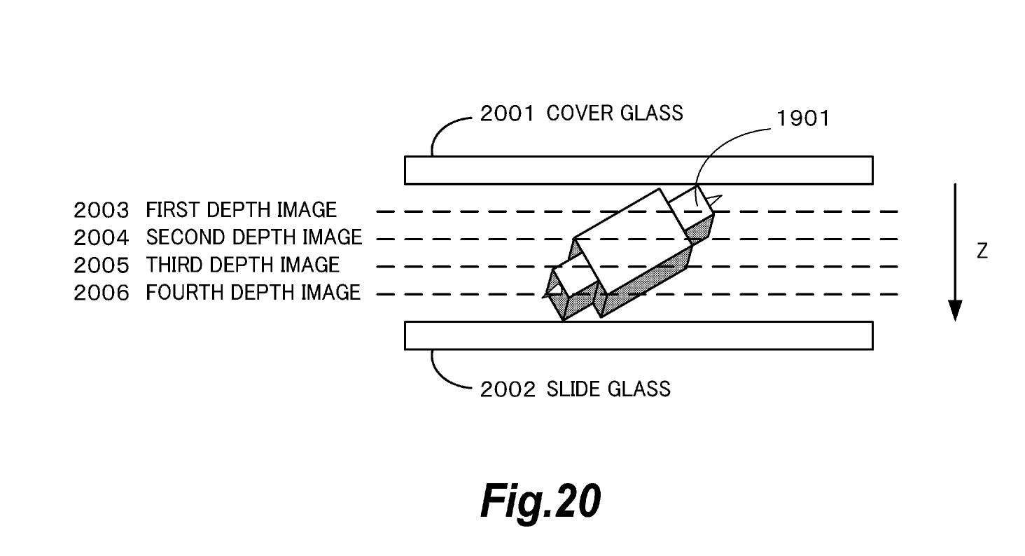

FIG. 20 is a schematic diagram illustrating acquisition of images of the three-dimensional specimen. FIG. 20 is a cross sectional view taken on a cross section perpendicular to the surface of a slide 206. The slide 206 is a piece prepared by placing a specimen (which is illustrated as a specimen model 1901) on a slide glass 2002 and fixing it under a cover glass 2001 with mounting agent. The specimen is a transparent object having a thickness from a few tens of micrometers to 100 micrometers. A depth image group is composed of a plurality of images captured by imaging the specimen at a plurality of depths (i.e. a plurality of positions with respect to the thickness direction). In the illustrative case described here, images captured by imaging at different depths include a first depth image 2003, a second depth image 2004, a third depth image 2005, and a fourth depth image 2006. The number of depths is not limited to that in this illustrative case. A three-dimensional specimen image that can reproduce the three-dimensional shape of the specimen is constructed from the depth image group. Imaging at larger numbers of depth enables construction of more precise three-dimensional specimen images.

### (Main Cross Section Based on Specimen Shape)

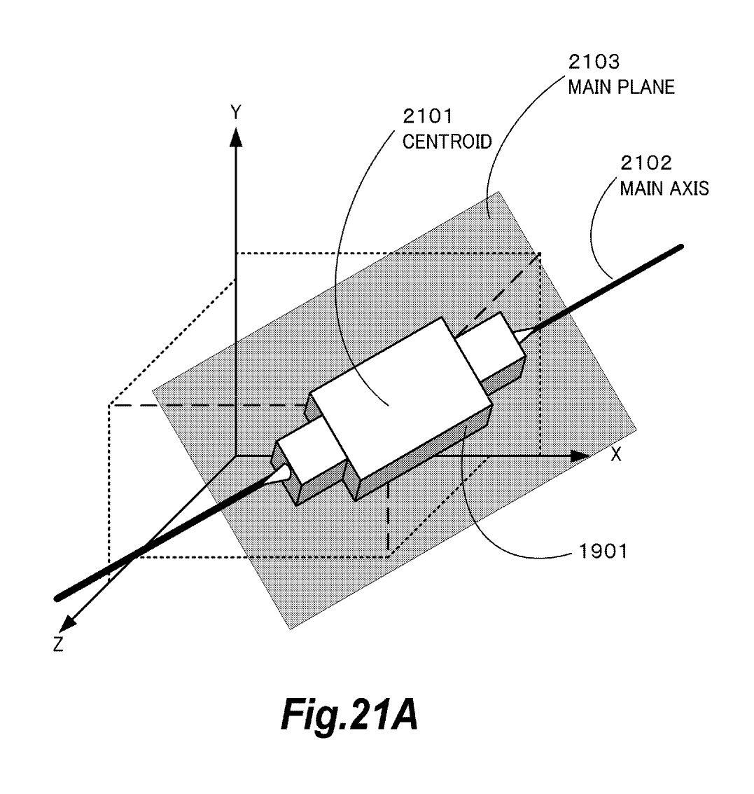

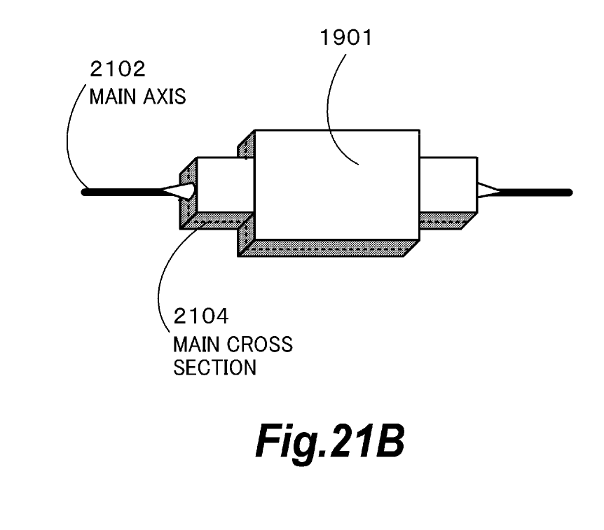

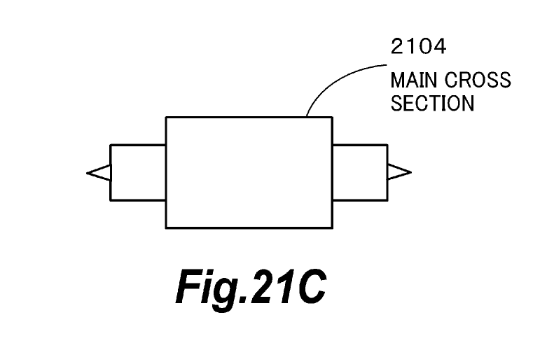

FIGS. 21A, 21B, and 21C are schematic diagrams illustrating the main cross section of the three-dimensional specimen.

FIG. 21A shows the specimen model 1901 with its geometric centroid 2101, main axis 2102, and main plane 2103. The main axis 2102 mentioned here is defined as an axis that passes through the geometric centroid 2101 and has the largest length inside the specimen model 1901. The main plane 2103 is defined as a plane that contains the main axis 2102 and has the largest area inside the specimen model 1901.

For the sake of simplicity, the specimen model 1901 is assumed to be an axisymmetric solid constructed as a combination of cuboids and cones. The main axis 2102 passes through the apexes of the two cones at both ends. The specimen model 1901 has the main axis 2102 and the main plane 2103 as shown in FIG. 21A.

FIG. 21B shows the specimen model 1901 with its main axis 2102 and main cross section 2104. The main cross section 2104 is defined as a cross section of the specimen model 1901 taken in the main plane 2103. FIG. 21B shows the main cross section 2104 of the specimen model 1901, and FIG. 21C shows the main cross section 2104 itself.

In the following, there will be described an illustrative case in which an image of the main cross section 2104 of the specimen model 1901 simulating an overlapped cell aggregate is displayed for observation by the user. In the case of a different specimen model, the method of determining a cross section to be displayed for observation by the user would be different. For example, in the case of a three-dimensional specimen in an Indian file arrangement (i.e. cells arranged in a row), the specimen may be projected onto a two-dimensional plane in such a way that its axis (i.e. the main axis in FIG. 21A) becomes longest, and this plane may be regarded as the main cross section.

### (Application Screen or Presented Image)

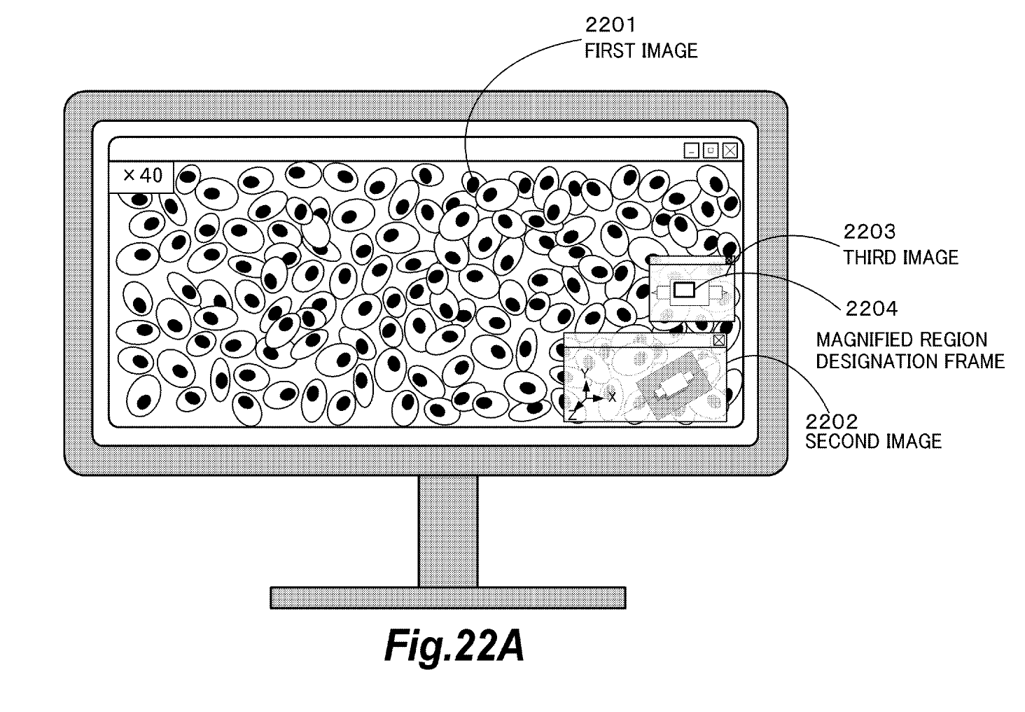

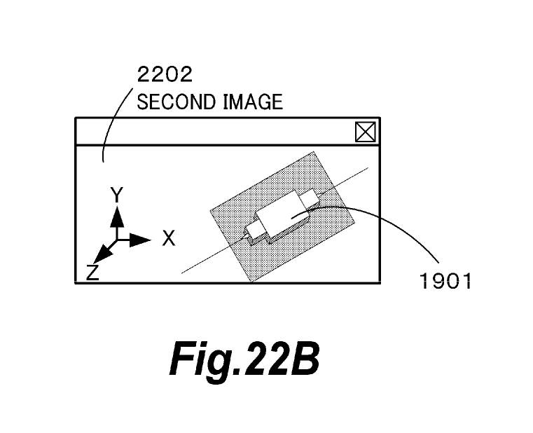

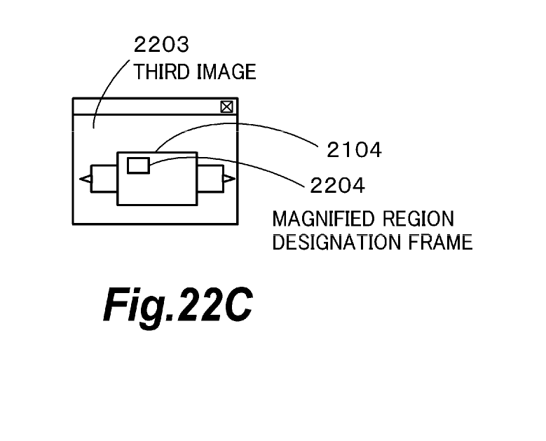

FIG. 22A shows an exemplary image presentation screen of an image presentation application according to the present invention.

FIG. 22A is an application screen displayed on the display apparatus 103. The application screen includes three windows, in which a first image 2201, a second image 2202, and a third image 2203 are displayed respectively.

FIG. 22B shows the window in which the second image 2202 is displayed. The second image 2202 three-dimensionally shows a three-dimensional specimen image constructed from depth images captured by imaging the portion of the slide 206 other than the label 601 at a plurality of different depths. In the illustrative case described herein, the three-dimensional specimen image of the specimen model 1901 is displayed three-dimensionally in the second image 2202 with its main axis 2102 and the main plane 2103. Moreover, the X, Y, and Z axes are also displayed in the second image 2202 in this illustrative case to help understanding of the orientation of the three-dimensional specimen image in the three-dimensional space.

The second image 2202 is not necessarily an image containing a plurality of individual specimens, but it may be an image containing one individual specimen. In the case where the second image 2202 contains a plurality of individual specimens, the image presentation application may be configured to allow the user to select one of the individual specimens at his/her discretion and to indicate the selected individual specimen by a specimen designation frame.

FIG. 22C shows the window in which the third image 2203 is displayed. The third image 2203 two-dimensionally shows the two-dimensional shape of the main cross section 2104 of the specimen model 1901 shown in the second image 2202. The third image 2203 is a rotated image rotated by the method described in the first embodiment with reference to FIGS. 9A to 14. The main cross section 2104 is a plane in the three-dimensional space. The rotation angle of such a plane can be computed as rotation angle that makes the normal of the main plane 2103 parallel to the Z axis and makes the main axis 2102 parallel to the X or Y axis.

In FIG. 22A, the window in which the second image 2202 is displayed, the window in which the third image 2203 is displayed, and information about the magnification are displayed in the window in which the first image 2201 is displayed in a superposed manner. The first image 2201 is a magnified image of the region designated by the magnified region designation frame 2204 in the third image 2203. The first image 2201 is used for detailed observation of the specimen. While the second image 2202 is a three-dimensional image, the first image 2201 and the third image 2203 are two-dimensional images.

The second image 2202 and the third image 2203 can be considered to be a base image and a derivative image, which are in a first reduction-magnification relationship. The third image 2203 and the first image 2201 can also be considered to be a base image and a derivative image, which are in a second reduction-magnification relationship. Presenting the magnified image of the main cross section of the second image 2202 as the first image 2201 enables efficient observation of the specimen. This method is based on the idea that the main cross section contains a large amount of information about the three-dimensional specimen.

### (Process of Determining Main Cross Section Based on Specimen Shape)

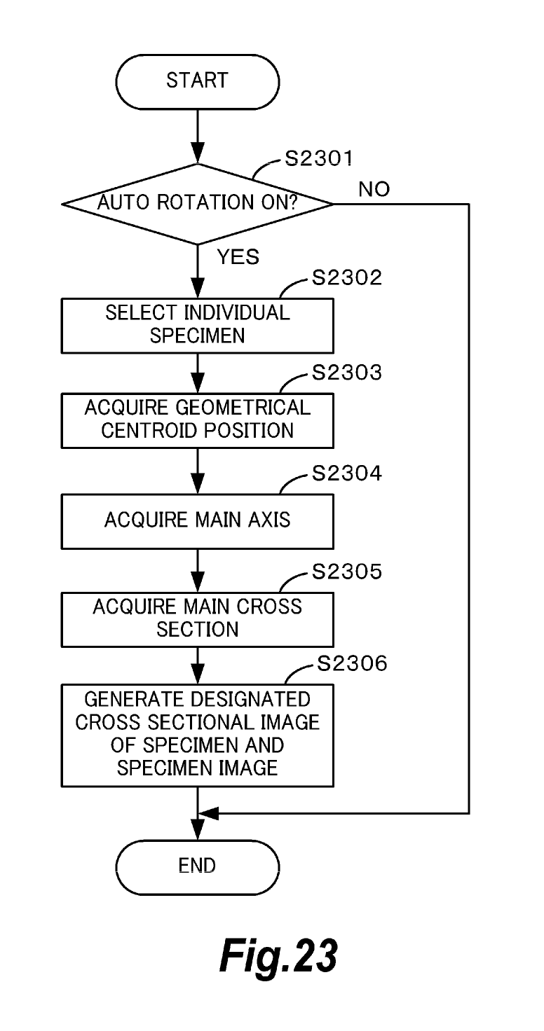

FIG. 23 is a flow chart of a process of forming an image of the main cross section of the three-dimensional specimen. The process of this flow chart is executed by the control unit 301 of the image processing apparatus 102, which executes the image presentation application.

In step S2301, the control unit 301 makes a determination as to whether or not auto-rotation is set to ON in the image presentation mode setting of the image presentation application. Auto-rotation can be set to ON by the user with the display menu described before with reference to FIG. 8. As the user operates the GUI of the image presentation application using the keyboard 311 and/or the mouse 312, a command according to the operation is input to the image processing apparatus 102 through the operation I/F 310.

Responsive to the input of the command, the control unit 301 executing the image presentation application sets the rotation mode in the image presentation mode setting and executes processing for drawing the application screen according to the setting. The setting information of the present image presentation mode of the image presentation application is stored in the main memory 302 or the sub-memory 303, and the control unit 301 can make a determination as to the setting of the image presentation mode on the basis of the information stored in the memory.

In step S2302, the control unit 301 accepts a user's command for selecting an individual three-dimensional specimen to acquire information about the individual three-dimensional specimen selected by the user. Specifically, the user performs an operation of selecting an individual three-dimensional specimen that he/she wishes to observe using the keyboard 311 and/or the mouse 312 in the window in which the second image is displayed in the application screen. Responsive to the operation, a command for selecting one of the individual three-dimensional specimens is input to the image processing apparatus 102 through the operation I/F 310. In this embodiment, there are not necessarily a plurality of specimens on the slide 206. If there is only one individual three-dimensional specimen on the slide 206, this step can be skipped.

In step S2303, the control unit 301 acquires information about the position of the geometric centroid of the individual three-dimensional specimen selected in step S2302. The position of the geometric centroid of each of the individual three-dimensional specimens has been computed beforehand, and information about the position of the geometric centroid is stored and held in the imaging apparatus 101, the storage device 308, or an apparatus in the network. The control unit 301 of the image processing apparatus 102 retrieves the information about the position of the geometric centroid of each of the individual three-dimensional specimens from the imaging apparatus 101, the storage device 308, or the apparatus in the network.

In step S2304, the control unit 301 acquires information about the main axis of the individual three-dimensional specimen selected in step S2302. The main axis of each of the individual three-dimensional specimens has been computed beforehand, and this information is stored and held in the imaging apparatus 101, the storage device 308, or an apparatus in the network. The control unit 301 of the image processing apparatus 102 retrieves the information about the position of the geometric centroid of each of the individual specimens from the imaging apparatus 101, the storage device 308, or the apparatus in the network.

In step S2305, the control unit 301 computes the main cross section of the individual three-dimensional specimen from the information about the position of the geometric centroid acquired in step S2303 and the information about the main axis acquired in step S2304.

In step S2306, the control unit 301 performs processing for drawing the main plane in the second image and processing of forming an image of the main cross section of the individual three-dimensional specimen. The control unit 301 applies rotation processing described in the first embodiment to the image of the main cross section thus formed to present the resultant image as the third image. Moreover, the control unit 301 performs processing for presenting as the first image a magnified image of the region designated by a magnified region designation frame in the third image. Specifically, the control unit 301 retrieves image data of the region designated by the magnified region designation frame in the third image, applies rotation processing to it to generate the first image.

The first image corresponds to the fourth image layer in the multi-layer image data shown in FIG. 5, which has the highest resolution. Therefore, the image rotation processing in generating the first image in step S2306 is rotation processing applied to a high-resolution image, which requires high-load processing. Therefore, the processing in steps 2303 through S2306 is not performed on the image of the individual three-dimensional specimen selected in step S2302 after it is selected, but the processing in steps S2303 through S2306 is performed in advance for each of the individual three-dimensional specimens. It is preferred that the rotated images be held in the storage device 308. The timing of performing the processing in steps S2303 through S2306 for each of the individual specimens may be, for example, immediately after imaging. When this is the case, the processing in steps S2303 through S2306 may be performed either in the imaging apparatus 101 or in the image processing apparatus 102.

According to this embodiment, a cross section of the three-dimensional specimen in a cross section different from the depth images captured by imaging is presented in a way that can lead to a reduction in the burden on the user during the observation. The depth images captured by imaging are, for example, images of the three-dimensional specimen in cross sections parallel to the surface of the slide, but the cross section of the three-dimensional specimen that the user wishes to observe is not necessarily the same as the cross section in which a depth image is captured.

According to this embodiment, a cross sectional image of the three-dimensional specimen in a cross section different from the cross sections in which the depth images are captured can be generated from the three-dimensional specimen image constructed from the plurality of depth images. Therefore, a cross sectional image of the three-dimensional specimen in a cross section that the user wishes to observe can be presented.

According to this embodiment, the cross sectional image of the three-dimensional specimen thus generated is rotated based on the shape and/or condition of the specimen, and the rotated image is presented. This leads to a reduction in the number of times of oblique shift of the observation area during screening, whereby user's trouble in operations such as scrolling can be reduced.

In this embodiment, an illustrative case in which a cross sectional image of the three-dimensional specimen in the main cross section is generated from the three-dimensional specimen image for presentation. This is an illustrative example having its basis in the assumption that the main cross section contains a large amount of information about the three-dimensional specimen. The cross section of the three-dimensional specimen in which an image to be presented is generated is not limited to limited to this.

### Third Embodiment

As the third embodiment, there will be described a case in which the screen of the image presentation application is composed of two windows.

The image processing apparatus according to the present invention can be used in an image processing system including an imaging apparatus and a display apparatus. The configuration of the image processing system, the functional blocks of the imaging apparatus in the image processing system, the hardware construction of the image processing apparatus, the functional blocks of the control unit of the image processing apparatus, the structure of multi-layer image data, and the construction of the slide are the same as those described in the description of the first embodiment and will not be described further.

In the first and second embodiments, the screen of the image presentation application is composed of three windows in which a first image (a magnified image), a second image (an overall image of the slide), and a third image (an image of an individual specimen) are displayed respectively. As the third embodiment, there will be described an exemplary image presentation application whose screen is composed of two windows, in which the first image and the second image are displayed but the third image is not displayed. The method of rotating an image for image presentation and processing implementing the same are same as those described above in the first and second embodiments. Specifically, image rotation is performed based on the shape or condition of the specimen or on the smallest circumscribed rectangle. The third embodiment differs from the first and second embodiments in the method of presentation of the rotated image.

### (Application Screen of Presented Image)

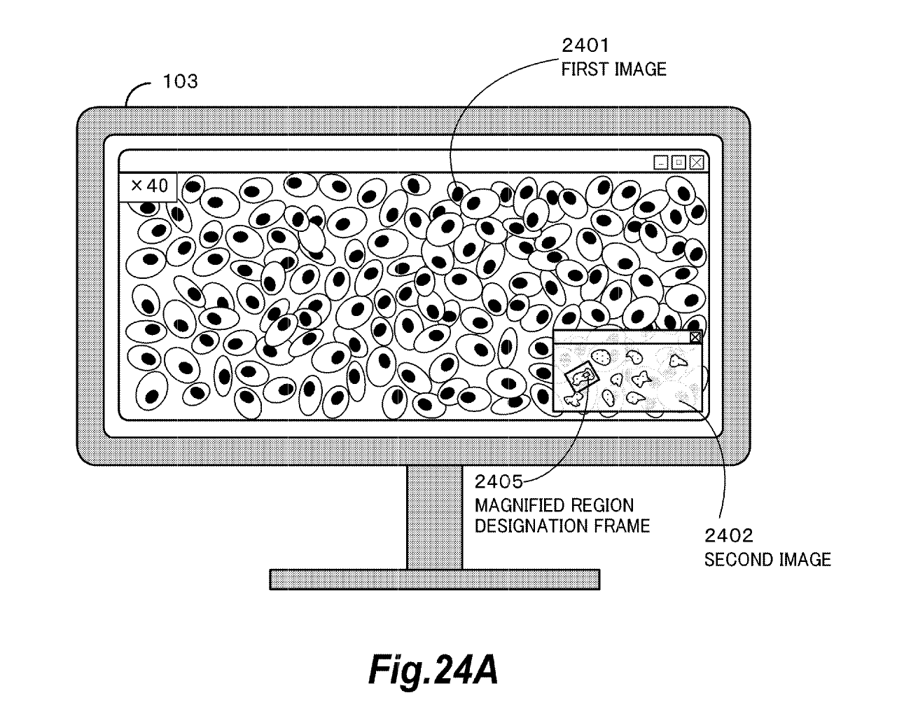

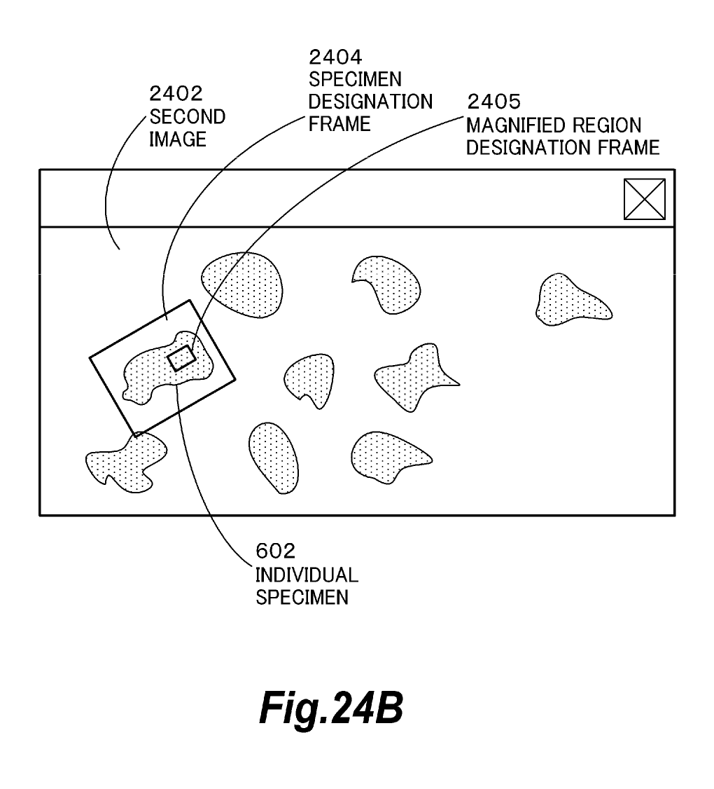

FIG. 24A shows an exemplary screen of the image presentation application according to the present invention.

FIG. 24A shows an application screen displayed on the screen of the display apparatus 103. This application displays two windows in which a first image 2401 and a second images 2402 are displayed respectively and information about the magnification in a superposed manner.

FIG. 24B shows the window in which the second image 2402 is displayed. The second image 2402 is an image captured by imaging the portion of the slide 206 other than the label 601. When a plurality of specimens are attached to the slide, the window in which the second image 2402 is displayed shows an image that allows the user to see or recognize all the specimens. The second image 2402 allows the user to select one specimen (individual specimen) from among the plurality of specimens. In the illustrative case shown in FIG. 24B, an individual specimen 602 is selected. The selected individual specimen is highlighted by a specimen designation frame 2404.

The second image 2402 further allows the user to designate a region of the individual specimen 602 to be displayed as the first image 2401 in a magnified manner. The region thus designated is indicated by a magnified region designation frame 2405. The specimen designation frame 2404 and the magnified region designation frame 2405 are rotated based on the shape, condition, or smallest circumscribed rectangle of the individual specimen 602 and displayed in the rotated orientation as with in the above-described embodiments. The first image 2401, which is a magnified image of the region designated by the magnified region designation frame 2405, is also a rotated image generated by rotating an original image.

In FIG. 24A, the window in which the second image 2402 is displayed and information about the magnification is displayed in the window in which the first image 2401 is displayed in a superposed manner. The first image 2401 is a magnified image of the region designated by the magnified region designation frame 2405 in the second image 2402. The first image 2401 is used for detailed observation of the specimen. When the user observes the individual specimen, the first image 2401 is used. The first image 2401 is a rotated image rotated by rotation processing based on the shape, condition, or smallest circumscribed rectangle of the selected individual specimen 602.

Therefore, as described with reference to FIGS. 17A to 17E, the user may shift the observation area sequentially in the vertical or horizontal direction in the first image 2401 in performing screening of the individual specimen 602, and the number of times of oblique shift of the observation area can be reduced. In this case, while the magnified region designation frame 2405 in the second image 2402 shifts sequentially in a direction oblique to the window in which the first image 2401 is displayed and the window in which the second image 2402 is displayed, this direction of shift is parallel or perpendicular to the sides of the specimen designation frame 2404.

### (Two-Window Display Layout for Three-Dimensional Specimen Image)

While FIGS. 24A and 24B show an exemplary image presentation intended for application to pathological tissue diagnosis, image presentation for a three-dimensional specimen intended mainly for application to pathological cytodiagnosis is also possible. In the latter case, a three-dimensional image of a specimen, a cross sectional image of the three-dimensional specimen in the main cross section, and a magnified region designation frame etc. are displayed in the second image 2402. Existing techniques for three-dimensional image display can be used to display the tree-dimensional image of the specimen. For example, to facilitate the visibility of the cross sectional image in the main cross section existing in the three dimensional specimen, the portion of the specimen other than the cross sectional image may be displayed in semi-transparent manner. Alternatively, a three-dimensional specimen image showing the three-dimensional specimen that is cut in such a way that the cross sectional image in the main cross section is exposed may be displayed.

As described above, it is possible to perform image presentation in such a way as to allow the user to see an overall image of the three-dimensional specimen and a cross sectional image displayed as the first image at the same time. This image presentation allows the user to easily know where in a cross section inside the three-dimensional specimen the region displayed as the magnified image as the first image 2401 is located. Furthermore, since the magnified image displayed as the first image 2401 is rotated based on the shape, condition, and/or inclination of a cross section inside the three-dimensional specimen displayed in the second image 2402, user's trouble in operations for shifting the observation area can be reduced.

In the illustrative case shown in FIGS. 24A and 24B, for example, operation of an arrow key causes the specimen observation area displayed in a magnified manner in the first image 2401 to shift in the vertical or horizontal direction in the first image 2401. On the other hand, the magnified region designation frame 2405 displayed in the second image 2402 shifts in an oblique direction in the second image 2402 in accordance with the image rotation angle. In the second image 2402, a three-dimensional specimen image like one shown in FIG. 22B is displayed. The image presentation application may be configured to rotate the three-dimensional specimen image based on, for example, the shape, condition, and/or inclination of the main cross section or to allow the user to manually rotate the three-dimensional specimen image. With this configuration, as an arrow key is operated to shift the observation area in the horizontal or vertical direction, not only the first image but also the magnified region designation frame displayed in the second image is shifted in the vertical or horizontal direction.

### Advantageous Effects

In this embodiment, the image presentation with only the first image (magnified image) and the second image (image of the slide) can make the window layout of the image presentation application simpler as compared to the first and second embodiments. Moreover, since the oblique shift of the observation area can be reduced by the image rotation based on the shape or condition of the specimen or a cross section of the specimen, the burden on the user can be reduced.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-287576, filed on Dec. 28, 2012, which is hereby incorporated by reference herein in its entirety.

What is claimed is:

1. An image processing apparatus configured to generate a display image used to display on a display apparatus a captured image captured by imaging a slide on which a specimen is placed by an imaging apparatus, comprising:
an acquisition unit configured to acquire an overall image generated from the captured image for displaying the entirety of the slide and a magnified image generated from the captured image for displaying a portion of the specimen in a magnified manner; and
a generation unit configured to generate a display image containing the overall image and the magnified image,
wherein the magnified image is a rotated image rotated relative to the overall image on the basis of specimen information about a feature of the specimen displayed in the magnified manner.

2. An image processing apparatus according to claim 1, wherein
the specimen information is information about at least one of a longest diameter axis defined as an axis that passes through the geometric centroid of the specimen and along which the diameter of the specimen is longest and a shortest diameter axis defined as an axis that passes through the geometric centroid of the specimen and along which the diameter of the specimen is shortest, and
the magnified image is an image rotated in such a way that the longest diameter axis or the shortest diameter axis is oriented horizontal or vertical in the display image.

3. An image processing apparatus according to claim 1, wherein
the specimen information is information about a smallest circumscribed rectangle having a smallest area among circumscribed rectangles of the specimen, and
the magnified image is an image rotated in such a way that a side of the smallest circumscribed rectangle is oriented horizontal or vertical in the display image.

4. An image processing apparatus according to claim 2, further comprising an input unit configured to accept from a user a designation of a scrolling direction in scrolling a region displayed in the magnified image in a constant direction during observation of the specimen, wherein the magnified image is rotated based on the designated scrolling direction.

5. An image processing apparatus according to claim 1, wherein
the specimen information is information about an area of the specimen suspected to be affected, and
the magnified image is an image rotated in such a way that the area of the specimen suspected to be affected is located at a predetermined position in the specimen.

6. An image processing apparatus according to claim 5, further comprising an input unit configured to accept from a user a designation as to from which position in the specimen to start observation of the specimen using the magnified image and with which of a normal area or an area suspected to be affected in the specimen to start the observation,
wherein the magnified image is rotated based on the designated position from which to start the observation and the designated area with which to start the observation.

7. An image processing apparatus according to claim 1, further comprising an input unit configured to accept from a user a command for rotating the magnified image,
wherein the magnified image is rotated based on the command by the user.

8. An image processing apparatus according to claim 1, wherein the overall image contains an orientation indication mark indicating the inclination of the magnified image relative to the overall image.

9. An image processing apparatus according to claim 1, wherein
the captured image comprises a plurality of depth images captured in the same imaging area and having focusing positions different along the vertical direction of the slide,
the overall image is an image generated from a depth image having the highest focusing quality over the entire area of the slide among the depth images, and
the magnified image is an image generated from a depth image having a highest focusing quality in the region displayed by the magnified image among the depth images.

10. An image processing apparatus according to claim 1, wherein
there are a plurality of specimens on the slide, and
the magnified image is rotated based on the specimen information of each of the plurality of specimens.

11. An image processing apparatus according to claim 1, wherein
the acquisition unit is configured to further acquire a specimen image for displaying the entirety of the specimen displayed in the magnified manner by the magnified image,
the generation unit is configured to generate the display image containing the overall image, the magnified image, and the specimen image, and
the specimen image is a rotated image rotated relative to the overall image base on the specimen information of the specimen displayed by the magnified image.

12. An image processing apparatus according to claim 11, wherein the angle of inclination of the specimen image relative to the overall image is equal to the angle of inclination of the magnified image relative to the overall image.

13. An image processing apparatus according to claim 11, wherein the overall image contains an orientation indication mark indicating the inclination of the specimen image relative to the overall image.

14. An image processing apparatus according to claim 11, wherein
there are a plurality of specimens on the slide, and
the specimen image is rotated based on the specimen information of each of the plurality of specimens.

15. An image processing apparatus according to claim 14, further comprising an input unit configured to accept from a user a designation for selecting a specimen to be displayed by the specimen image from among the plurality of specimens, wherein the designation for selecting the specimen can be input by an operation of moving a pointer in the overall image onto a region over which the specimen to be selected exists or a predetermined region around the region over which the specimen to be selected exists.

16. An image processing apparatus according to claim 1, wherein
the captured image is a three-dimensional image constructed based on a plurality of depth images captured in the same imaging area and having focusing positions different along the vertical direction of the slide so as to reproduce a three-dimensional shape of the specimen,
the overall image is an image three-dimensionally displaying the three-dimensional shape of the specimen,
the magnified image is an image displaying a cross section of the three-dimensional shape of the specimen in a magnified manner, and
the magnified image is rotated based on the specimen information about the cross section displayed in the magnified manner.

17. An image processing apparatus according to claim 11, wherein
the captured image is a three-dimensional image constructed based on a plurality of depth images captured in the same imaging area and having focusing positions different along the vertical direction of the slide so as to reproduce a three-dimensional shape of the specimen,
the overall image is an image three-dimensionally displaying the three-dimensional shape of the specimen,
the magnified image is an image displaying a cross section of the three-dimensional shape of the specimen in a magnified manner,
the specimen image is an image two-dimensionally displaying a two-dimensional shape of the entirety of the cross section displayed by the magnified image, and
the specimen image is rotated based on the specimen information about the cross section displayed by the magnified image.

18. A control method for an image processing apparatus configured to generate a display image used to display on a display apparatus a captured image captured by imaging a slide on which a specimen is placed by an imaging apparatus, comprising:
an acquisition step of acquiring an overall image generated from the captured image for displaying the entirety of the slide and a magnified image generated from the captured image for displaying a portion of the specimen in a magnified manner; and
a generation step of generating a display image containing the overall image and the magnified image,
wherein the magnified image is a rotated image rotated relative to the overall image on the basis of specimen information about a feature of the specimen displayed in the magnified manner.

19. A program that causes a computer to control an image processing apparatus configured to generate a display image used to display on a display apparatus a captured image captured by imaging a slide on which a specimen is placed by an imaging apparatus, the program causing the computer to execute:
an acquisition step of acquiring an overall image generated from the captured image for displaying the entirety of the slide and a magnified image generated from the captured image for displaying a portion of the specimen in a magnified manner; and
a generation step of generating a display image containing the overall image and the magnified image,
wherein the magnified image is a rotated image rotated relative to the overall image on the basis of specimen information about a feature of the specimen displayed in the magnified manner.

20. An image processing system comprising an image processing apparatus according to claim 1, an imaging apparatus, and a display apparatus, wherein the image processing apparatus acquires the captured image from the imaging apparatus and outputs the display image to the display apparatus.

21. An image processing apparatus configured to generate a display image used to display on a display apparatus a captured image captured by imaging a slide on which a plurality of specimens are placed by an imaging apparatus, comprising:
an acquisition unit configured to acquire an overall image generated from the captured image for displaying the entirety of the slide, a specimen image for displaying the entirety of a selected specimen among the plurality of specimens, and a magnified image for displaying a portion of the specimen displayed by the specimen image in a magnified manner; and
a generation unit configured to generate a display image containing the overall image, the specimen image, and the magnified image,
wherein the specimen image is an image rotated relative to the overall image on the basis of specimen information about a feature of the specimen displayed by the specimen image, and the magnified image is an image not rotated relative to the specimen image.

22. A control method for an image processing apparatus configured to generate a display image used to display on a display apparatus a captured image captured by imaging a slide on which a plurality of specimens are placed by an imaging apparatus, comprising:
an acquisition step of acquiring an overall image generated from the captured image for displaying the entirety of the slide, a specimen image for displaying the entirety of a selected specimen among the plurality of specimens, and a magnified image for displaying a portion of the specimen displayed by the specimen image in a magnified manner; and
a generation step of generating a display image containing the overall image, the specimen image, and the magnified image,
wherein the specimen image is an image rotated relative to the overall image on the basis of specimen information about a feature of the specimen displayed by the specimen image, and the magnified image is an image not rotated relative to the specimen image.
